(19) United States
(12) Patent Application Publication
(10) Pub. No.: US 2026/0366856 A1
(43) Pub. Date: Nov. 19, 2026

(54) AUTOMATED HIGH-ACCURATE SPECTRAL CALIBRATION APPARATUS OF DIFFUSE-REFLECTION SPECTRAL SENSOR

(71) Applicant: Si-Ware Systems, Cairo (EG)

(72) Inventors: Bassem Mortada, Cairo (EG); Yasser M. Sabry, Cairo (EG); Mohamed Metwally, Cairo (EG); Mohamed El Arabawy, Cairo (EG); Ahmed Shebl, Cairo (EG); Ahmed Darweesh, Cairo (EG); Samir Abozyd, Tanta (EG); Mohamed Sayed Mohamed Ismail, Cairo (EG); Islam Samir Seleman El-Sayed, Cairo (EG); Mohamed Usama Mohamed Aly Shoureap, Cairo (EG); Amir Khaled Abdelhamid Mohamed Shahin, Cairo (EG)

(21) Appl. No.: 19/669,251

(22) Filed: May 6, 2026

Related U.S. Application Data
(60) Provisional application No. 63/801,540, filed on May 7, 2025.

(51) Int. Cl. G01B 9/02055

(52) U.S. Cl. CPC G01B 9/02074

(57) ABSTRACT

Aspects relate to automated high-accurate spectral calibration of diffuse-reflection spectral sensors to maintain the unit to unit variation below an acceptable level. A calibration apparatus can include a motorized positioning mechanism configured to automatically alternately position one or more of a plurality of optical elements within an optical path of the diffuse-reflection spectral sensor. The calibration apparatus can further include a control and processing unit configured to control the motorized positioning mechanism and the diffuse-reflection spectral sensor to dynamically switch between a first calibration state based on wideband light and a first selected optical element and a second calibration state based on narrowband light and a second selected optical element and to acquire respective detected signals from the diffuse-reflection spectral sensor in each of the first calibration state and the second calibration state to produce calibration data based on the detected signals.

### PRIORITY CLAIM

This application claims priority to and the benefit of Provisional Application No. 63/801,540, filed in the U.S. Patent and Trademark Office on May 7, 2025, the entire content of which is incorporated herein by reference as if fully set forth below in its entirety and for all applicable purposes.

### TECHNICAL FIELD

The technology discussed below relates generally to optical spectroscopy and interferometry, and in particular to calibration of spectral sensors.

### BACKGROUND

In Fourier Transform Infrared (FTIR) spectrometers, a movable mirror is used to introduce an optical path difference between the two arms of the interferometer. The optical path difference modulates the output intensity at detector, due to interference of the two beams of interferometer arms. The modulated output intensity is called an interferogram, and is expressed as following (discarding the DC component):

$$I ( x ) = {\int }_{- ∞}^{∞} B ( v ) cos ( 2 π vx ) dv$$

where I is the output intensity, x is the optical path difference, v is the wavenumber (reciprocal of wavelength λ), and B is the spectrum of the input signal. To extract the spectrum from the interference (interferogram) signal, Fourier transform is applied to it, and to enable that, the optical path difference (OPD) should be known precisely. When the input spectrum is a sharp spectral line as for the case of laser beam, the interferogram signal follows a sinusoidal waveform, where two consecutive zero crossings correspond to an optical path difference x of λ/2. Based on this correspondence, the optical path difference can be determined from the detected signal with time.

Generally, all modem FTIR spectrometers use the interference pattern of monochromatic light of a built-in He—Ne laser to detect the change in optical path difference, and this is implemented by adding another auxiliary interferometer or by having a different beam path for the laser within the interferometer, such that while the infrared source interferogram signal is measured, the optical path difference variation is calibrated by the sinusoidal interference pattern resulting from the laser. However, the additional built-in laser source adds more complexity of alignment in addition to the extra cost of the laser source.

Moreover, traditional spectral calibration of benchtop spectrometers requires a complicated alignment of the optical components and spectral calibration procedures. For different spectroscopy applications, chemometric calibration models are being built using a few master units, and to use each new benchtop spectrometer product, a calibration transfer step is usually applied to be able to use the product. This is affordable for low volume production of expensive benchtop spectrometers. However, moving to handheld miniaturized spectrometers and spectral sensors, with promised high production volumes, an automated highly accurate calibration setup is needed. Such a calibration setup should guarantee producing a large number of spectral sensors with highly reproducible spectral response within a predefined level of accepted error. Consequently, this enables building chemometric models on a few master spectral sensors for different spectroscopic applications, without a need to model transfer for the rest of large volume.

### SUMMARY

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In an example, an apparatus configured for automated spectral calibration is provided. The apparatus includes a diffuse-reflection spectral sensor including a light modulation module. The apparatus further includes a motorized positioning mechanism configured to automatically alternately position one or more of a plurality of optical elements within an optical path of the diffuse-reflection spectral sensor. The apparatus further includes a control and processing unit configured to control the motorized positioning mechanism and the diffuse-reflection spectral sensor to dynamically switch between at least a first calibration state to direct a first optical signal based on wideband light and a first selected optical element of the plurality of optical elements to the light modulation module and a second calibration state to direct a second optical signal based on narrowband light and a second selected optical element of the plurality of optical elements to the light modulation module, where the control and processing unit is further configured to acquire respective detected signals from the diffuse-reflection spectral sensor in each of the first calibration state and the second calibration state and produce calibration data based on the detected signals.

Another example provides a method for delay compensation of a diffuse-reflection spectral sensor including a MEMS interferometer including a moveable mirror and a fixed mirror. The method includes setting a delay value for the diffuse-reflection spectral sensor. The method further includes capturing a capacitance signal versus time and a corresponding interferogram current signal versus time of a white light interferogram recorded by the diffuse-reflection spectral sensor for both directions of mirror displacement across the travel range of the moveable mirror. The method further includes identifying two white light interferogram bursts of the white light interferogram from the interferogram current signal and extracting a calculated capacitance difference value and a calculated delay value between the interferogram current signal and the capacitance signal based on the white light interferogram bursts. The method further includes adjusting the delay value based on at least one of the calculated capacitance difference value or the calculated delay value being greater than a threshold value.

Another example provides a method for self-apodization calibration of a diffuse-reflection spectral sensor. The method includes capturing a narrowband interferogram signal by the diffuse-reflection spectral sensor, where the diffuse-reflection spectral sensor includes a micro-electromechanical systems (MEMS) interferometer including a moveable mirror and a fixed mirror. The method further includes extracting an envelope of the narrowband interferogram signal and producing a self-apodization calibration function based on the extracted envelope, where the self-apodization calibration function is configured to compensate for self-apodization resulting from light diffraction during movement of the moveable mirror.

Another example provides a method for self-apodization calibration of a diffuse-reflection spectral sensor that includes MEMS interferometer including a moveable mirror and a fixed mirror. The method includes extracting a known envelope of a known interferogram of a known material at one or more wavelength ranges, extracting a measured envelope of a measured interferogram signal of the known material at the one or more wavelength ranges, and dividing the known envelope by the measured envelope to produce a self-apodization calibration function configured to compensation for self-apodization resulting from light diffraction during movement of the moveable mirror.

These and other aspects of the disclosure will become more fully understood upon a review of the detailed description, which follows. Other aspects, features, and examples of the present disclosure will become apparent to those of ordinary skill in the art, upon reviewing the following description of specific, exemplary aspects of the present disclosure in conjunction with the accompanying figures. While features of the present disclosure may be discussed relative to certain examples and figures below, all examples of the present disclosure can include one or more of the features discussed herein. In other words, while one or more examples may be discussed as having certain features, one or more of such features may also be used in accordance with the various examples of the disclosure discussed herein. In similar fashion, while exemplary aspects may be discussed below as device, system, or method aspects, it should be understood that such exemplary aspects can be implemented in various devices, systems, and methods.

### BRIEF DESCRIPTION OF THE DRAWINGS

FIG. 1 is a diagram illustrating a spectrometer according to some aspects.

FIG. 2 illustrates an example of an apparatus configured for automated spectral calibration according to some aspects.

FIG. 3 is a functional block diagram illustrating a calibration and testing apparatus as an Automated Testing Equipment (ATE) according to some aspects.

FIG. 4 is a diagram illustrating an example of an automated spectral calibration apparatus according to some aspects.

FIG. 5 is a diagram illustrating another example of an automated spectral calibration apparatus according to some aspects.

FIG. 6 is a diagram illustrating another example of an apparatus configured for automated spectral calibration according to some aspects.

FIG. 7 is a flow diagram illustrating an exemplary spectral calibration flow according to some aspects.

FIG. 8 is a diagram illustrating a white light interferogram measurement according to some aspects.

FIG. 9 is a flow diagram illustrating an example flow of self-apodization extraction and compensation according to some aspects.

FIG. 10 is a diagram illustrating a self-apodization envelope for a spectral sensor extracted using filters of 1550 nm and 2000 nm according to some aspects.

FIG. 11 is a diagram illustrating self-apodization envelopes obtained using interpolation using envelopes extracted with filters of 1550 nm and 2000 nm according to some aspects.

FIG. 12 is a diagram illustrating a Talc Spectrum that contains two sharp peaks at 1393 nm and 2307 that could be used for envelope extraction using deconvolution according to some aspects.

FIG. 13 is a flow diagram illustrating deconvolution across wavelength according to some aspects.

FIG. 14 is a diagram illustrating an example of an apparatus configured for testing after spectral calibration according to some aspects.

FIG. 15 is a diagram illustrating another example of an apparatus configured for automated spectral calibration according to some aspects.

FIG. 16 is a diagram illustrating another example of an apparatus configured for automated spectral calibration according to some aspects.

FIGS. 17A and 17B are diagrams illustrating other examples of an apparatus configured for automated spectral calibration according to some aspects.

FIG. 18 is a diagram illustrating another example of an apparatus configured for automated spectral calibration according to some aspects.

FIG. 19 is a diagram illustrating another example of an apparatus configured for automated spectral calibration according to some aspects.

FIG. 20 is a diagram illustrating another example of an apparatus configured for automated spectral calibration and specular back-reflection measurement according to some aspects.

FIGS. 21A and 21B are diagrams illustrating examples of specular back-reflection sources according to some aspects.

FIG. 22 is a diagram that illustrates an example of a back-reflection calibration apparatus according to some aspects.

FIGS. 23A-23D are diagrams illustrating examples of a spectral calibration apparatus including different external calibration light sources according to some aspects.

FIG. 24 is a diagram illustrating another example of an apparatus configured for automated spectral calibration according to some aspects.

FIG. 25 is a diagram illustrating another example of an apparatus configured for automated spectral calibration according to some aspects.

FIG. 26 is a diagram illustrating another example of an apparatus configured for automated spectral calibration according to some aspects.

FIGS. 27A and 27B illustrate a reflection mode calibration according to some aspects.

FIGS. 28A and 28B illustrate another reflection mode calibration according to some aspects.

FIGS. 29A-29C are diagrams illustrating other examples of apparatuses configured for automated spectral calibration according to some aspects.

FIGS. 30A-30D are diagrams illustrating examples of a rotating calibration wheel according to some aspects.

FIGS. 31A-31C are diagrams illustrating another example of an apparatus configured for automated spectral calibration according to some aspects.

FIG. 32 is a diagram illustrating an example of vertical axis alignment according to some aspects.

FIG. 33 is a diagram illustrating an example of horizontal axis alignment according to some aspects.

FIG. 34 is a diagram illustrating an exemplary process for delay compensation of a diffuse-reflection spectral sensor according to some aspects.

FIG. 35 is a diagram illustrating an exemplary process for self-apodization compensation of a diffuse-reflection spectral sensor according to some aspects.

FIG. 36 is a diagram illustrating another exemplary process for self-apodization compensation of a diffuse-reflection spectral sensor according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Spectral calibration affects the spectroscopic accuracy and controls the accuracy of spectral sensors. Various aspects are directed to mechanisms for automated high-accurate spectral calibration of diffuse-reflection spectral sensors to maintain the unit to unit variation below an acceptable level.

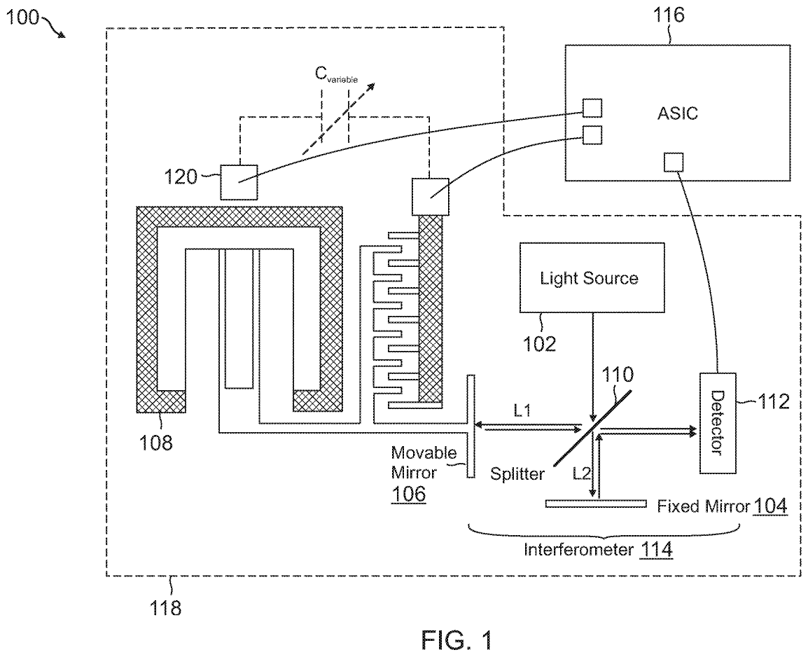

FIG. 1 is a diagram illustrating a spectrometer 100 according to some aspects. The spectrometer 100 may be, for example, a Fourier Transform infrared (FTIR) spectrometer. In the example shown in FIG. 1, the spectrometer 100 includes a Michelson FTIR interferometer. In other examples, the spectrometer may include an FTIR Fabry-Perot interferometer, tunable filter, dispersive spectrometer, or other type of spectrometer.

FTIR spectrometers measure a single-beam spectrum (power spectral density (PSD)), where the intensity of the single-beam spectrum is proportional to the power of the radiation reaching the detector. In order to measure the spectrum of a sample, a background PSD (i.e., the single-beam spectrum in absence of a sample) may first be measured (e.g., prior to each sample measurement, periodically, or based on other factors) to compensate for any instrument transfer function(s). The single-beam spectrum of light transmitted, reflected, or trans-reflected from the sample under test (i.e., the sample PSD) may then be measured. The absorbance of the sample may be calculated from the transmittance, reflectance, or trans-reflectance of the sample. For example, the transmission, reflection, or trans-reflection spectrum of the sample may be calculated as the ratio of the PSD of the sample to the background PSD. The absorbance may then be obtained as, for example, −log 10 (sample spectrum).

In the example shown in FIG. 1, the spectrometer 100 includes an interferometer 114 that includes a fixed mirror 104, a moveable mirror 106, a beam splitter 110, and a detector 112 (e.g., a photodetector). A light source 102 associated with the spectrometer 100 is configured to emit an input beam and to direct the input beam towards the beam splitter 110. The light source 102 may include, for example, a laser source, one or more wideband thermal radiation sources, or a quantum source with an array of light emitting devices that cover the wavelength range of interest.

The beam splitter 110 is configured to split the input beam into two beams. One beam is reflected off of the fixed mirror 104 back towards the beam splitter 110, while the other beam is reflected off of the moveable mirror 106 back towards the beam splitter 110. The moveable mirror 106 may be coupled to an actuator 108 to displace the movable mirror 106 to the desired position for reflection of the beam. An optical path length difference (OPD) is then created between the reflected beams that is substantially equal to twice the mirror 106 displacement. In some examples, the actuator 108 may include a micro-electro-mechanical systems (MEMS) actuator, a thermal actuator, or other type of actuator.

The reflected beams interfere at the beam splitter 110 to produce an output light beam, allowing the temporal coherence of the light to be measured at each different Optical Path Difference (OPD) offered by the moveable mirror 106. The signal corresponding to the output light beam may be detected and measured by the detector 112 at many discrete positions of the moveable mirror 106 to produce an interferogram. In some examples, the detector 112 may include a detector array or a single pixel detector. The interferogram data versus the OPD may then be input to a processor (not shown, for simplicity). The spectrum may then be retrieved, for example, using a Fourier transform carried out by the processor.

In some examples, the spectrometer 100 may be implemented as a MEMS device 118 (e.g., a MEMS chip or MEMS interferometer). The MEMS chip 118 may then be attached to a printed circuit board (PCB), not shown, that may include, for example, one or more processors, memory devices, buses, and/or other components. In some examples, the PCB may include a spectral analyzer or other processor (e.g., application-specific integrated circuit (ASIC) 116) configured to receive and process the spectrum to produce spectral data. As used herein, the term MEMS refers to the integration of mechanical elements, sensors, actuators and electronics on a common silicon substrate through microfabrication technology. For example, the microelectronics are typically fabricated using an integrated circuit (IC) process, while the micromechanical components are fabricated using compatible micromachining processes that selectively etch away parts of the silicon wafer or add new structural layers to form the mechanical and electromechanical components. One example of a MEMS element is a micro-optical component having a dielectric or metallized surface working in a reflection or refraction mode. Other examples of MEMS elements include actuators, detector grooves and fiber grooves.

In the example shown in FIG. 1, the MEMS interferometer 118 may include the fixed mirror 104, moveable mirror 106, beam splitter 110, and MEMS actuator 108 for controlling the moveable mirror 106. In addition, the MEMS interferometer 118 may include fibers for directing the input beam towards the beam splitter 110 and the output beam from the beam splitter 110 towards the detector (e.g., detector 112). In some examples, the MEMS interferometer 118 may be fabricated using a Deep Reactive Ion Etching (DRIE) process on a Silicon On Insulator (SOI) wafer in order to produce the micro-optical components and other MEMS elements that are able to process free-space optical beams propagating parallel to the SOI substrate. For example, the electro-mechanical designs may be printed on masks and the masks may be used to pattern the design over the silicon or SOI wafer by photolithography. The patterns may then be etched (e.g., by DRIE) using batch processes, and the resulting chips (e.g., MEMS chip 118) may be diced and packaged (e.g., attached to the PCB).

For example, the beam splitter 110 may be a silicon/air interface beam splitter (e.g., a half-plane beam splitter) positioned at an angle (e.g., 45 degrees) from the input beam. The input beam may then be split into two beams L1 and L2, where L1 propagates in air towards the moveable mirror 106 and L2 propagates in silicon towards the fixed mirror 104. Here, L1 originates from the partial reflection of the input beam from the half-plane beam splitter 110, and thus has a reflection angle equal to the beam incidence angle. L2 originates from the partial transmission of the input beam through the half-plane beam splitter 110 and propagates in silicon at an angle determined by Snell's Law. In some examples, the fixed and moveable mirrors 104 and 106 are metallic mirrors, where selective metallization (e.g., using a shadow mask during a metallization step) is used to protect the beam splitter 110. In other examples, the mirrors 104 and 106 are vertical Bragg mirrors that can be realized using, for example, DRIE.

In some examples, the MEMS actuator 108 may be an electrostatic actuator formed of a comb drive and spring. For example, by applying a voltage to the comb drive, a potential difference results across the actuator 108, which induces a capacitance therein, causing a driving force to be generated as well as a restoring force from the spring, thereby causing a displacement of moveable mirror 106 to the desired position for reflection of the beam back towards the beam splitter 110.

The unique information from the vibrational absorption bands of a molecule is reflected in an infrared spectrum that may be produced, for example, by the spectrometer 100 shown in FIG. 1. By applying spectral numerical processing and statistical analysis to a spectrum using, for example, the ASIC 116, the information in the spectrum may be identified or otherwise classified. The application of statistical methods to the analysis of experimental data is traditionally known as chemometrics, and more recently as artificial intelligence based on machine learning models.

Spectral calibration of the FTIR spectrometer 100 shown in FIG. 1 typically requires a mirror positioning calibration step. As an extra laser source and auxiliary interferometer each increase the cost and complexity of the spectrometer system, calibration of the mirror positioning may use the relation between capacitance change of the MEMS comb drive actuator 108 and displacement thereof, and consequently the OPD. Capacitive sensing of the capacitance change (C_{variable}) of the comb-drive actuator 108 can be performed using, for example, a capacitive sensing circuit 120, and the resulting capacitance signal can be input to the ASIC 116 to calculate the capacitance-to-OPD (C2X). In some examples, a laser source (not shown) may be used to calibrate the capacitive sensing technique just once, and then when the capacitive sensing is calibrated, there is no need for a laser source again as the capacitive sensing technique is used to determine the position of the mirror electronically during the operation of the device.

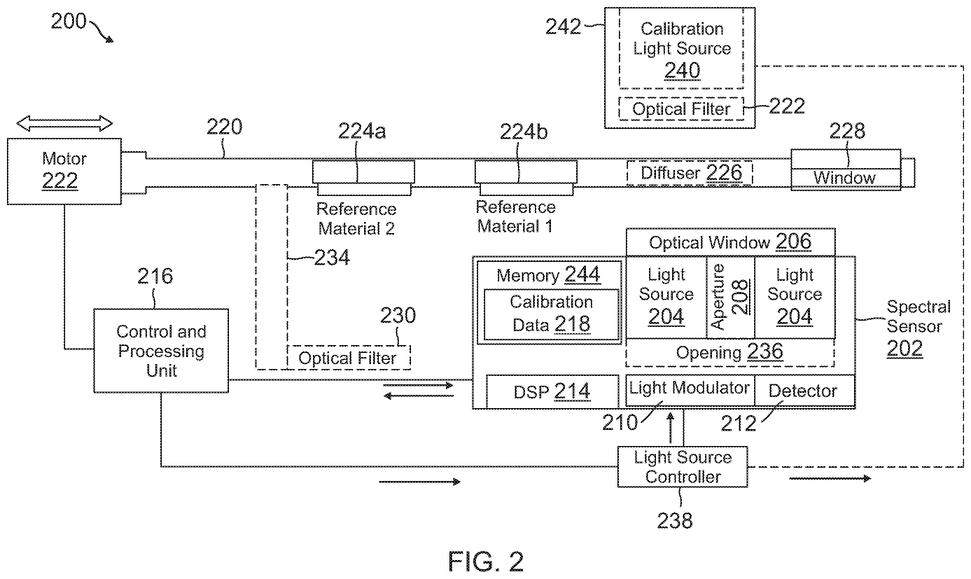

FIG. 2 illustrates an example of an apparatus configured for automated spectral calibration according to some aspects. The apparatus 200 (e.g., calibration apparatus) includes a diffuse-reflection spectral sensor 202 configured to operate in a diffuse-reflectance mode. In some examples, the diffuse-reflection spectral sensor 202 may also operate in other transmission and/or reflection modes. The spectral sensor 202 includes a light source 204 (e.g., an optical head) configured to generate input light and to direct the input light towards an optical window 206 for specular reflection thereof back into an optical aperture 208 of the spectral sensor 202. In examples in which a sample-under-test (SUT) or other reference material, not shown, is placed on the optical window 206, the input light from the optical head 204 can be diffusely reflected from the SUT/reference material and the diffusely reflected light is then directed via the optical aperture 208 towards a light modulator 210 configured to modulate the diffusely reflected light to produce modulated light and a detector 212 (e.g., a photodetector or array of photodetectors) configured to detect the modulated light and produce an output signal corresponding to an interferogram (e.g., interferogram signal) representing a measurement of the SUT. The spectral sensor 202 can further include an on-chip processor 214 (e.g., a digital signal processor (DSP)) configured to process the interferogram signal to produce a spectrum (e.g., a power spectral density (PSD)) of the SUT. The DSP 214 can further be configured to process the spectrum to obtain one or more characteristics of the SUT.

The light source 204 may be, for example, a wideband light source (e.g., a white light source or light source that covers a broad range of wavelengths). The wideband light source can include, for example, one or more filament bulbs (e.g., incandescent bulbs) or light emitting diodes (LEDs) configured to direct the input light (illumination light) towards the optical window 206. The light modulator 210 may include, for example, a Michelson interferometer, a Fabry-Perot cavity, a spatial light modulator, or a birefringent device. For example, the light modulator 210 may include a MEMS interference device, such as the MEMS based interferometer, as shown in FIG. 1. The MEMS interferometer enables generating a spectrum in millisecond time scale since the moving micromirror is driven by a MEMS actuator.

Although not shown, the spectral sensor 202 may further include illumination optics, such as one or more reflectors and/or lenses (not shown) configured to direct the input light towards the optical window 206. In addition, although not shown, the spectral sensor 202 may further include collection optics, such as one or more reflectors and/or lenses (not shown) configured to direct the diffusely reflected light towards the light modulator 210 and/or the modulated light towards the detector 212.

The apparatus 200 further includes a control and processing unit 216 configured to control the spectral sensor 202 and calibrate the spectral sensor 202 to produce calibration data 218 (e.g., one or more calibration parameters) that can be stored, for example, on a memory 244 of the spectral sensor 202 and used by the DSP 214 to process the interferogram signal. In some examples, the memory 244 may be on the DSP. In other examples, the memory 244 may be a separate memory device on the spectral sensor 202. The control and processing unit 216 and on-chip DSP 214 may each include, for example, a single processing device or a plurality of processing devices. Such a processing device may be a microprocessor, micro-controller, digital signal processor, microcomputer, central processing unit, field programmable gate array, programmable logic device, logic circuitry, analog circuitry, digital circuitry, and/or any device that manipulates signals (analog and/or digital) based on hard coding of the circuitry and/or operational instructions. The control and processing unit 216 and on-chip DSP 214 may further include a memory, such as a flash memory or other suitable memory to store software (e.g., processor-executable code) and/or data (e.g., calibration data 218).

The control and processing unit 216 may be coupled, for example, to a motorized positioning mechanism 220 configured to automatically alternately position one or more of a plurality of optical elements within an optical path of the spectral sensor 202. In the example shown in FIG. 2, the motorized positioning mechanism 220 includes a motor 222 configured to displace the motorized positioning mechanism 220 to move one or more of the optical elements into the optical path of the spectral sensor 202 (e.g., above the optical window 206 of the spectral sensor 202). For example, the optical elements may include one or more reference materials, two of which 224a and 224b are shown for convenience. Examples of reference materials 224a and 224b may include, but are not limited to, polytetrafluoroethylene (PTFE)/Spectralon, polystyrene, and rare-earth oxides. In addition, the optical elements may include an optical diffuser 226, an external optical window 228, an optical filter (e.g., optical bandpass filter) 230 or 232, and various other optical elements, such as lenses, mirrors, etc.

In some examples, as illustrated in FIG. 2, the motorized positioning mechanism 220 may include a motorized Y-stage (e.g., a motorized Y-stage slider, as shown, or a motorized Y-stage rotating wheel) on which one or more of the optical elements 224-232 may be placed. In some examples, the motorized Y-stage slider 220 can include a plurality of sockets, each configured to hold one of the optical elements 224-232. In the example shown in FIG. 2, the motorized Y-stage slider 220 can hold the various reference materials 224a and 224b, the optical diffuser 226, and the external optical widow 228. However, it should be understood that the optical elements held by the Y-stage slider 220 are not limited to the optical elements shown in FIG. 2 and may include more, fewer, or different optical elements.

In addition, the motorized positioning mechanism 220 can further include an extension 234 below the slider on which the optical filter 230 can be positioned. In the example shown in FIG. 2, lateral (Y-direction) motion of the motorized positioning mechanism 220 can be performed to insert the optical filter 230 into an opening 236 in the spectral sensor 202 to position the optical filter 230 above the light modulator 210 (e.g., between the optical aperture 208 and the light modulator 210). The control and processing unit 216 can be configured to control lateral displacement of the motorized Y-stage slider 220 to position a desired optical element (or multiple optical elements) above the optical window 206 of the spectral sensor 202 and/or to insert the optical filter 230 into the spectral sensor 202.

The control and processing unit 216 may further be coupled, for example, to a light source controller 238 configured to control the optical head (internal light source) 204 of the spectral sensor 202. For example, the light source controller 238 can be configured to turn on/off the light source 204 as a whole or to turn on one or more bulbs/LEDs of the light source, while turning other bulbs/LEDs off. The light source controller 238 can further be configured to control an external calibration light source 240 that is external to the spectral sensor 202. For example, the external calibration light source 240 may be included within an external housing and/or positioned on a Z-stage 242 of the motorized positioning mechanism 220. In the example shown in FIG. 2, the external housing or Z-stage 242 can further optionally include optical filter 232. The external light source 240 can be, for example, a single wavelength light source (e.g., a laser) or a wideband light source (e.g., white light source).

In an example, the control and processing unit 216 can be configured to control the motorized positioning mechanism 220, the spectral sensor 202, and the light source controller 238 to enable calibration of the spectral sensor 202 by dynamically switching between at least a first calibration state to direct a first optical signal based on wideband light and a first selected optical element of the plurality of optical elements (e.g., one or more of the reference materials 224a or 224b) to the light modulation module 210 of the spectral sensor 202 and a second calibration state to direct a second optical signal based on narrowband light and a second selected optical element of the plurality of optical elements (e.g., the optical filter 230 or 232 and/or diffuser 226, or other optical element, such as a lens) to the light modulation module 210. For example, the control and processing unit 216 can be configured to enable calibration using the internal wideband light source(s) 204 of the diffuse-reflection spectral sensor 202 by diffusely reflecting light from one or more reference materials 224a/224b in the first calibration state, in addition to using the external light source 240 with light passing through the optical filter 230 or 232 to produce narrowband light that is directed through the optical aperture/opening 208 in the second calibration state. The control and processing unit 216 can switch between the calibration states in an automated manner to facilitate highly accurate calibration of multiple diffuse-reflection spectral sensors on the production line. For example, the control and processing unit 216 may be configured to receive the interferogram signal(s) obtained in the first and second calibration states and to perform different calibration procedures and compensation mathematical functions to produce the calibration data 218.

In an example, the external light source 240 is a single wavelength light source (e.g. Laser) and the control and processing unit 216 can be configured to move the motorized positioning mechanism to position the optical diffuser 226 in the optical path of the spectral sensor 202 in the second calibration state. In this example, output light from the single wavelength light source 240 is optically coupled to the optical diffuser 226 to emulate diffuse reflection from a sample to be measured by the spectral sensor 202 under calibration, such that the illumination behaves like the diffuse reflection from the sample under test but with a single wavelength/narrowband light illumination. This way of calibration enables measuring and adjusting the spectral resolution of the spectral sensor 202 to ensure all spectral sensor units achieve the same spectral resolution. The optical diffuser 226 can be illuminated using a wide spot collimated light from the external light source 240 to ensure proper uniformity of the illumination pattern. In an example, the optical diffuser 226 may be rotating around its optical axis to average the spatial variations across its area. In some examples, the optical diffuser 226 can be a transmission diffuser or a reflection diffuser arranged at a 45° with respect to the spectral sensor 202 and the light source 240. In addition, the optical filter 232 within the external housing/Z-stage 242 can further be used to illuminate the spectral sensor under calibration with a narrowband light.

In another example, the control and processing unit 216 can be configured to control the motorized positioning mechanism 220 in the second calibration state to insert the optical filter 230 inside the spectral sensor 202 and position a reference material 224a (e.g., Reference Material 2) facing the spectral sensor optical head 204. The reference material 224a positioned over the optical window 206 of the spectral sensor 202 can be configured to diffusely reflect the input light coming from the light source 204 of the spectral sensor towards the aperture 208, which can then be filtered by the optical filter 230 prior to providing the diffusely reflected and filtered light to the light modulator 210 of the spectral sensor 202.

In another example, the control and processing unit 216 can be configured to control the motorized positioning mechanism 220 in the first calibration state to position a reference material 224b (e.g., Reference Material 1) facing the spectral sensor optical head 204. The reference material 224b positioned over the optical window 206 of the spectral sensor 202 can be configured to diffusely reflect the input light coming from the light source 204 of the spectral sensor towards the aperture 208, which can then be directed to the light modulator 210 of the spectral sensor 202.

In some examples, to keep the external light source (e.g., single wavelength laser) 240 spectrum stable and spectrally aligned with narrowband optical filter 230/232, a Thermo-Electric Cooling TEC module (not shown) can be used to control the laser diode temperature and fine tune its radiation spectrum. Optical fibers (not shown) can also be used together with the external light source 240 in some examples to illuminate the spectral sensor(s) 202 under calibration. Spectral calibration can be also done across the spectral range using gas discharge calibration external light sources 240, or multiple narrowband optical filters 230/232 attached to the motorized positioning mechanism 220 (e.g., translation stage) and illuminated by an external wide band light source 240, external plasma laser source 240 or an external super-continuum laser source 240. Multiple narrowband optical filters 230/232 can be also coupled to multiple external LEDs or laser diodes (LDs) 240. In other examples, an external wide band light source 240 can be coupled with a multiband optical filter and an adaptive digital filter.

In some examples, although not shown in FIG. 2, the motorized positioning mechanism 220 may be configured to control movement of the diffuse-reflection spectral sensor 202 instead of the plurality of optical elements. In this example, plurality of optical elements may be positioned on a fixed horizontal board and the motorized positioning mechanism 220 may be configured to move the diffuse-reflection spectral sensor 202 to position the diffuse-reflection spectral sensor 202 under one of the optical elements such that the optical path of the diffuse-reflection spectral sensor is aligned with that optical element.

The calibration apparatus 200 shown in FIG. 2 can therefore be configured to automate measurement of different reference materials, powder samples, optical windows, etc., to minimize the spectral differences between different spectral sensors/devices without adding expensive restrictions on the manufacturing tolerances. Examples of calibration procedures and compensation mathematical functions include mirror positioning, wavelength correction, self-apodization and instrument line shape variations compensation, specular back-reflection correction, photometric correction, and spectral transfer across the spectral sensors on the production line. The apparatus 200 shown in FIG. 2 can perform not only the calibration, but also the testing, of spectral sensor(s) 202 in a simple, fast and automated way suitable for the production lines of high performance interferometers.

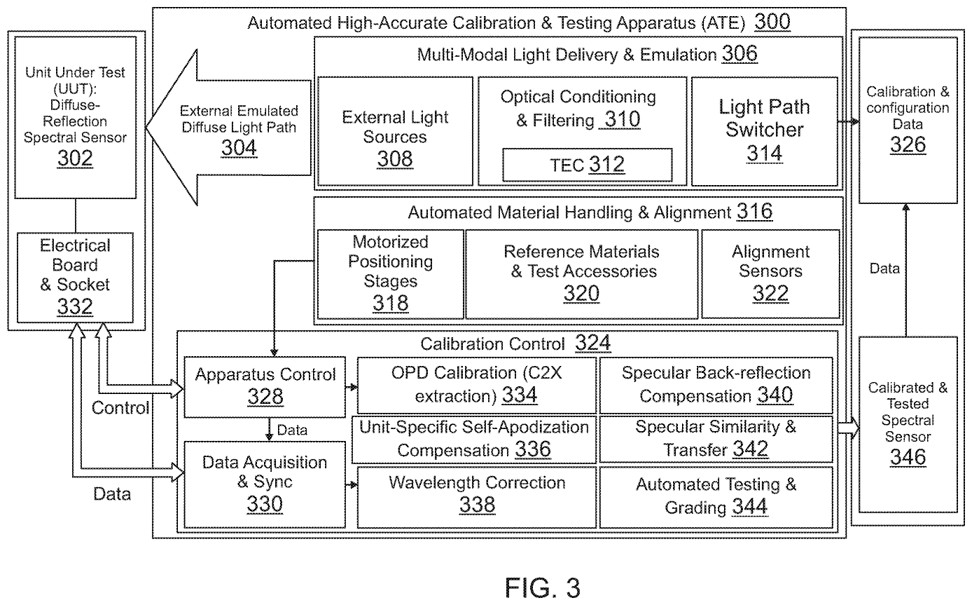

FIG. 3 is a functional block diagram illustrating the calibration and testing apparatus shown in FIG. 2 as an Automated Testing Equipment (ATE) 300 designed specifically for the mass production and highly accurate calibration of miniaturized, diffuse-reflection spectral sensors (such as MEMS-based FTIR spectrometers). Conventionally, benchtop spectrometers require expensive built-in lasers and complicated manual alignment. The ATE 300 shown in FIG. 3 solves that problem by providing a fully automated, external calibration station that burns the necessary calibration and configuration data 326 (referred to herein as one or more calibration parameters) directly onto the spectral sensor's memory, allowing the sensor to operate accurately in the field without internal reference lasers.

A major challenge in calibrating diffuse-reflection sensors (e.g., a diffuse-reflection spectral sensor unit under test (UUT) 302, which may include, for example, a MEMS based FTIR interferometer) is that standard laser calibration setups do not mimic how the sensor actually collects light in the real world. Therefore, the ATE 300 shown in FIG. 3 includes a multi-modal light delivery and emulation module 306 that is configured to emulate diffuse reflection from a sample by optically coupling a single-wavelength light source (e.g., a laser) to an engineered optical diffuser via an external emulated diffuse light path 304 through the internal sensor light path (e.g., via an optical aperture/opening in the spectral sensor). The multi-modal light delivery and emulation module 306 can include, for example, one or more external light sources 308 (e.g., laser diodes, filament lamps, LEDs, superluminescent diodes (SLEDs), laser diodes (LDs), plasma lasers, super-continuum laser sources, etc. The multi-mode light delivery and emulation module 306 can further include optical conditioning and filtering devices 310, which can include, for example, lenses, optical filters (e.g., single or multiband optical filters), optical fibers, transmission/reflection optical diffusers (which may be rotating or non-rotating), and other suitable devices. In addition, the optical conditioning and filtering devices 310 may include a TEC 312 to fine-tune and lock the laser diode's temperature for laser stability. The multi-mode light delivery and emulation module 306 can further include a light path switcher 314 that, in an automated manner, switches between calibration states that use the spectral sensor's internal wideband light source and those that use the external narrowband light source.

To enable high-volume production, the ATE 300 can further include an automated material handling and alignment module 316 that motorizes and automates the physical handling of calibration materials, thus removing the need for human intervention. The automated material handling and alignment module 316 includes motorized positioning stage(s) 318, reference materials and test accessories 320, and alignment sensors 322. For example, the motorized positioning stage(s) 318 can include a Y-stage slider or rotating wheel equipped with multiple sockets for materials 320. The sockets can automatically cycle through different reference materials and test accessories 320, such as optical filters, transmission lenses, back-reflection accessory windows (e.g., window “jigs”), and standard reference materials, such as polystyrene, rare-earth oxides, talc powder, and/or PTFE/Spectralon. The motorized positioning stage(s) 318 can further include a motorized Z-stage to move the entire assembly up and down for focus and proximity placement. For example, the Z-stage can include a proximity sensor (e.g., alignment sensor 322) to detect the exact distance to the unit under test 302, ensuring repeatable physical contact or focus distance for every spectral sensor coming off the production line.

The ATE 300 can further include a calibration control module 324 configured to synchronize the mechanical movements with data acquisition (e.g., capturing the spectral sensor's interferograms and capacitive signals) to extract complex mathematical correction functions and produce calibration and configuration data 326 (e.g., calibration parameters) to be stored on the spectral sensor memory. For example, the calibration control module 324 can include an apparatus control module 328 configured to control internal and external light sources, motorized positioning stage(s) 318, and other sensors (e.g., alignment sensors 322). The apparatus control module 328 can further operate together with a data acquisition and synchronization (sync) module 330 to synchronize interferograms and MEMS capacitance signals captured on the UUT 302. The apparatus control module 328 and data acquisition and sync module 330 can collectively be configured to perform calibration and testing of the UUT 302 via an electrical board and socket 332 that provides connectivity to the UUT 302 and supports control and data streams between the ATE 300 and the UUT 302.

The calibration control module 324 further includes various calibration and testing modules controlled by the apparatus control module 328 and data acquisition and sync module 330. The calibration and testing modules can include, for example, an OPD calibration module 334 configured to perform C2X extraction from narrowband signals. For example, instead of a continuous internal laser, the OPD calibration module 334 uses the external narrowband signal to establish a strict mathematical relationship between the MEMS mirror's capacitance of the UUT 302 and its Optical Path Difference (C2X). Once this C2X data (e.g., as part of the calibration and configuration data 326) is saved to the sensor's flash memory, the sensor can determine its mirror position electronically in the field without needing a laser again. The calibration and testing modules can further include a unit-specific self-apodization compensation module 336 configured to extract the envelope of the interference signal (interferogram signal) to correct for visibility decay caused by light diffraction during the mirror's movement of the UUT 302, a wavelength correction module 338 configured to apply a multiple linear regression polynomial to correct wavelength errors across the entire spectral range using multiple peaks of diverse reflection materials to cover the full range, and a specular back-reflection compensation module 340 configured to measure and correct non-linear absorbance from the sensor's own optical window or one or more external accessory windows. The self-apodization compensation function, wavelength correction function, and specular back-reflection compensation functions can then be burned onto the sensor's memory as part of the calibration and configuration data 326.

The calibration control module 324 can further include a specular similarity and transfer module 342 configured to produce a golden sensor transfer function to transfer the calibration and configuration data 326 to other spectral sensors on the production line. In addition, the calibration control module 324 can include an automated testing and grading module 344 configured to check the resolution, accuracy, and repeatability of the calibration and configuration data 326 to produce calibrated and tested spectral sensor(s) 346 on the production line. For example, the automated testing and grading module 344 can be configured to use one or more reference materials to test the calibration and configuration data 326 and modify the calibration and configuration data 326, as needed.

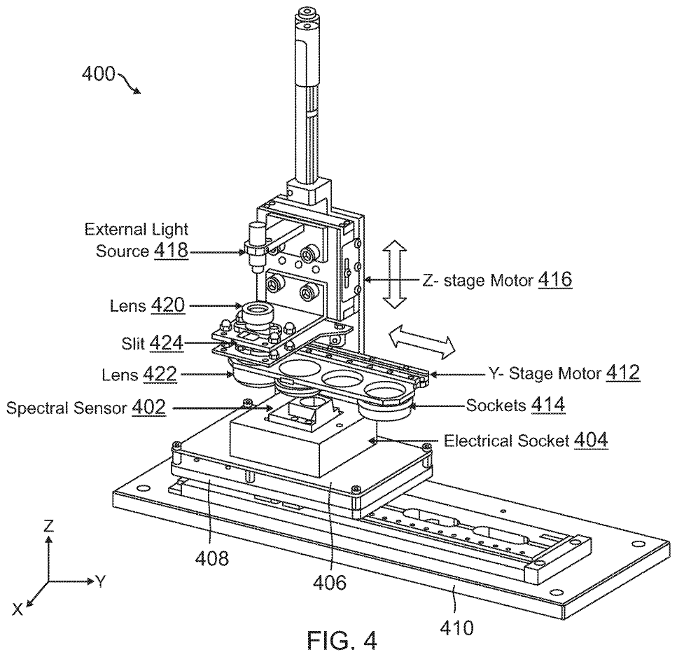

FIG. 4 is a diagram illustrating an example of an automated spectral calibration apparatus according to some aspects. In the example shown in FIG. 4, the automated spectral calibration apparatus 400 is configured to automatically calibrate a diffuse-reflection spectral sensor 402. The diffuse-reflection spectral sensor 402 can be placed within an electrical socket 404 configured to hold and provide electrical connection to the diffuse-reflection spectral sensor 402 during calibration and testing thereof. The electrical socket 404 can be included on an electrical board 406 configured to facilitate electrical connection with and to stream data from the spectral sensor 402 via the socket 404. The electrical board 406 may be positioned on a board holder 408 configured to move (provide translational motion to) the electrical board 406 containing the socket 404 and spectral sensor 402 via a rail 410. For example, the rail 410 can be configured as part of a production line to calibrate and test multiple spectral sensors (e.g., each positioned within a separate socket 404 on a separate electrical board 406 and rolling on the slide 410 via a separate board holder 408) in an automated manner.

The automated spectral calibration apparatus 400 further includes a Y-stage stepper motor/slider 412 including a plurality of slots/sockets 414 configured to hold optical elements, including, for example, lenses, reference materials, optical filters, optical windows, optical diffusers, etc. The Y-stage stepper motor/slider 412 is configured to control and move the sockets 414 laterally (e.g., in the y-direction) to position one of the sockets 414 above the spectral sensor 402 based on a current measurement being performed by the automated spectral calibration apparatus 400. The automated spectral calibration apparatus 400 further includes a Z-stage motor 416 that holds the entire Y-stage motor 412 and an external light source 418 (e.g., a white light or other wideband lamp or narrowband or single-wavelength light source). The rail 410 can further be configured to align the external light source 418 with the spectral sensor 402. In some examples, the external light source 418 can be contained within a housing that may further include an optional optical filter that may be inserted or removed into the housing.

The Z-stage motor 416 is configured to move the Y-stage motor 412 up and down (e.g., in the z-direction) to align the Y-stage motor 412 with the spectral sensor 402. For example, the Z-stage motor 416 can facilitate automatic alignment of an optional lens system (e.g., including Lenses 420 and 422) positioned on the Z-stage motor 416 on either side of the Y-stage motor 412 in case of a transmission measurement through an optical element (e.g., an optical filter, optical window, or lens) contained in the socket 404 positioned above the spectral sensor 402. In addition, the Z-stage motor 416 can move an optical element (e.g., a reference material) contained in the socket 404 positioned above the spectral sensor 402 to be contact with the optical window of the spectral sensor in case of a reflection measurement from the optical element. In some examples, the Z-stage motor 416 can further include one or more slits 424, each configured to receive a sample material or an optical filter in a transmission mode of the spectral sensor 402 (e.g., using the external light source 418 instead of the internal light source).

The automated spectral calibration apparatus 400 shown in FIG. 4 enables calibration by the external light source 418 and the internal light sources (not shown) of the diffuse reflection spectral sensor 402. In an example, the external light source 418, along with an optical bandpass filter (not shown) configured within an external housing containing the external light source 418 can generate narrowband light that passes through the internal light source aperture/opening of the spectral sensor 402. In this example, the socket 404 positioned above the spectral sensor 402 may include an optical diffuser to emulate diffuse reflection of the narrowband light directed through the aperture/opening of the spectral sensor. In another example, the external light source 418 can generate narrowband or wideband light that is passed through the aperture to an optical filter inserted into the spectral sensor 402 to provide narrowband light to the light modulator (e.g., MEMS interferometer) in the spectral sensor.

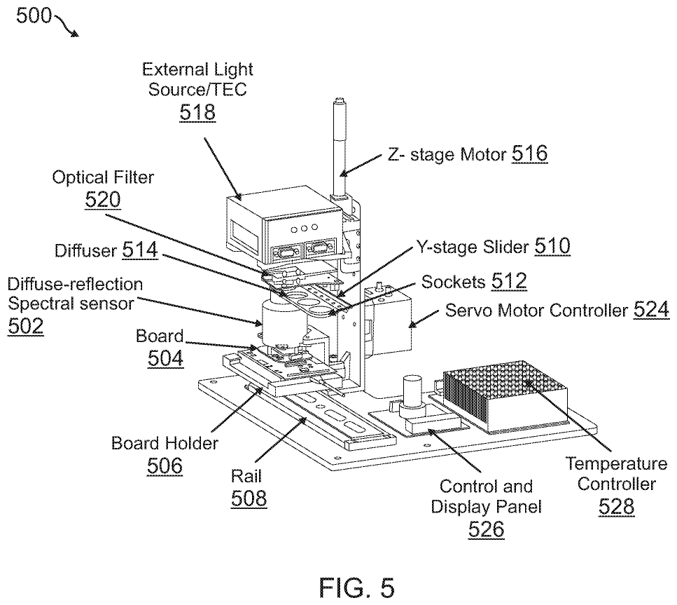

FIG. 5 is a diagram illustrating another example of an automated spectral calibration apparatus according to some aspects. In the example shown in FIG. 5, the automated spectral calibration apparatus 500 is configured to automatically calibrate a diffuse-reflection spectral sensor 502. The diffuse-reflection spectral sensor 502 can be placed on an electrical board 504 configured to hold and provide electrical connection to the diffuse-reflection spectral sensor 502 and to stream data from the spectral sensor 502 during calibration and testing thereof. The electrical board 504 may be positioned on a board holder 506 configured to move (provide translational motion to) the electrical board 504 containing the spectral sensor 502 via a rail 508. For example, the rail 508 can be configured as part of a production line to calibrate and test multiple spectral sensors (e.g., each positioned on a separate electrical board 504 and rolling on the slide 508 via a separate board holder 506) in an automated manner.

The automated spectral calibration apparatus 500 further includes a Y-stage slider 510 including a plurality of slots/sockets 512 configured to hold optical elements, including, for example, lenses, reference materials, optical filters, optical windows, optical diffusers, etc. For example, one of the sockets 512 may be configured to hold an optical diffuser 514. The Y-stage slider 510 is configured to control and move the sockets 512 laterally (e.g., in the y-direction) to position one of the sockets 512 (e.g., the socket containing the optical diffuser 514) above the spectral sensor 502 based on a current measurement being performed by the automated spectral calibration apparatus 500.

The automated spectral calibration apparatus 500 further includes a Z-stage 516 that holds the entire Y-stage slider 510 and an external light source 518. In the example shown in FIG. 5, the external light source 518 is a laser source that includes a TEC module to control the laser diode temperature and fine tune its radiation spectrum. The rail 508 can further be configured to align the external light source 518 with the spectral sensor 502. In the example shown in FIG. 5, the external light source 518 can further be optically coupled to an optical filter 520 that may be removably inserted within an external housing (e.g., the laser diode/TEC mount 518) or secured to the Z-stage 516, the latter being illustrated in FIG. 5. The laser source 518 can have its line width wider than the optical bandpass filter 520 to ensure stable spectral line position with temperature and time. The Z-stage motor 516 is configured to move the Y-stage slider 510 up and down (e.g., in the z-direction) to align the Y-stage motor 510 with the spectral sensor 502.

The automated spectral calibration apparatus 500 can further include a servo motor controller 524 configured to control the Y-stage slider 510 and Z-stage 516. In addition, the automated spectral calibration apparatus 500 can further include a control and display panel 526 (e.g., control and processing unit and display panel), along with a temperature controller 528 for the automated spectral calibration apparatus 500.

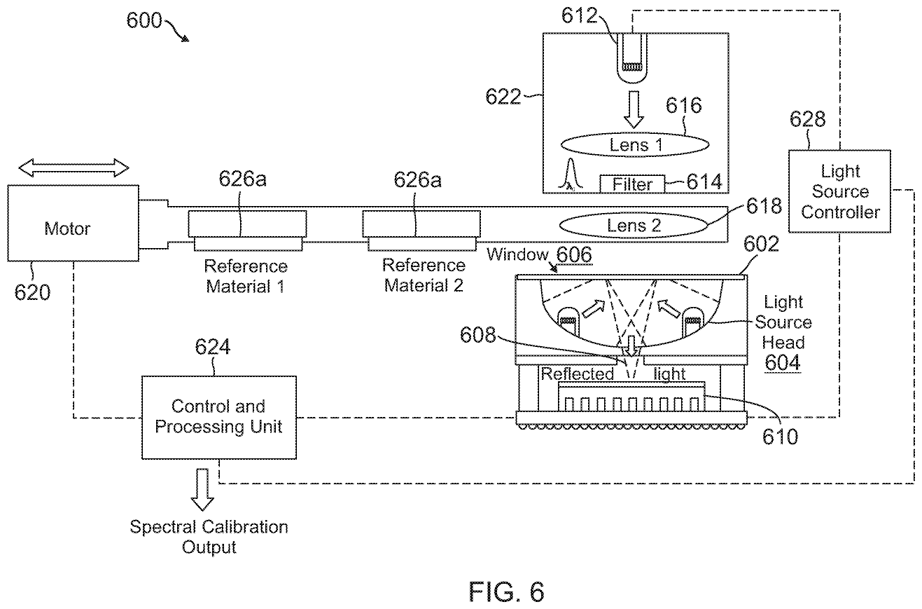

FIG. 6 is a diagram illustrating another example of an apparatus configured for automated spectral calibration according to some aspects. The apparatus 600 (e.g., calibration apparatus) includes a diffuse-reflection spectral sensor 602 configured to operate in a diffuse-reflectance mode. In some examples, the diffuse-reflection spectral sensor 602 may also operate in other transmission and/or reflection modes. The spectral sensor 602 includes a light source 604 (e.g., an optical head) configured to generate input light and to direct the input light towards an optical window 606 on which a sample-under-test (SUT), not shown, may be placed. The input light from the optical head 604 can be diffusely reflected from the SUT and the diffusely reflected light is then directed via an optical aperture 208 towards a light modulation chip 610 including a light modulator/detector (e.g., a MEMS based spectrometer). The light modulation chip 610 can further include an on-chip processor (not shown) configured to process an interferogram signal produced by the detector.

The normal calibration process of MEMS based spectrometers depends on taking a laser measurement of a certain wavelength λₒ to calibrate the capacitive sensing technique just once, and then when the capacitive sensing is calibrated there is no need for a laser source again as the capacitive sensing technique is used to determine the position of the mirror electronically during the operation of the device.

In the example shown in FIG. 6, instead of a laser source, the apparatus 600 can include an external white light filament 612 followed by a narrow band filter (optical narrow bandpass filter) 614 at the desired wavelength to be used for calibration. Two lenses 616 and 618 are used to couple the narrowband light to the MEMS spectrometer (light modulation chip 610). The apparatus 600 is fully automated using a Y-stage motor 620 and a Z-stage motor 622 that can be controlled by a control and processing unit 624 configured to execute, for example, calibration and testing software. In the example shown in FIG. 6, the second lens 618 is positioned on the Y-stage motor 620, along with one or more reference materials 626a and 626b. In addition, the control and processing unit 624 is further coupled to a light source controller 628 configured to control the internal light source head 604 of the spectral sensor 602 and the external light source 612.

In an example, the Y-stage motor 620 is moved to position the optical filter 614 above the spectral sensor 602, then the Z-stage motor 622 is moved up and down in fine steps. At each step, the coupled power from the optical filter 614 is measured, with the best alignment being achieved when the coupled power is at its maximum value. At this point, an interferogram is taken by the light modulation chip 610 and provided to the control and processing unit 624 to calibrate the capacitive sensing technique in the MEMS based spectrometer (light modulation chip 610).

In some examples, the Z-stage 622 includes a slit/slot (not shown) into which the optical filter 614 may be inserted. With this configuration, the transmission spectra of other materials may be measured by removing the optical filter 614 and inserting the other material into the slit/slot or by removing the optical filter 614 and moving the Y-stage 620 such that a reference material 626a/626b positioned on the Y-stage 620 is above the spectral sensor 602. The Z-stage 622 also provides the capability of doing automated alignment to account for the change in the used material.

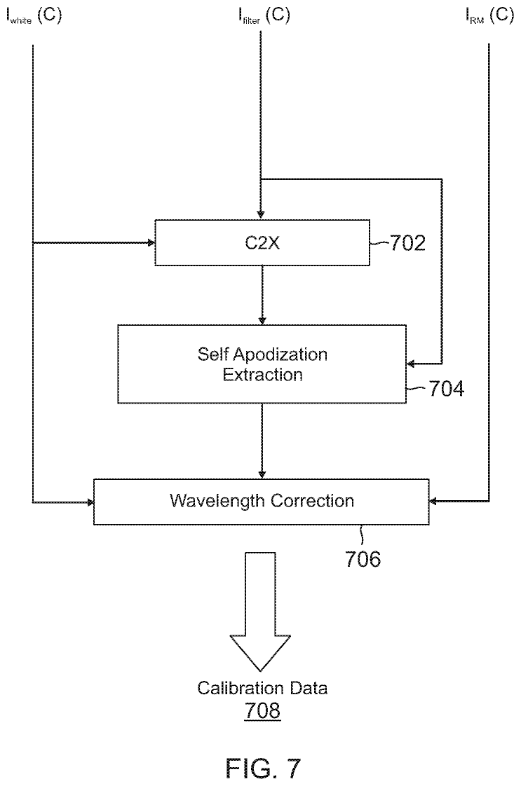

FIG. 7 is a flow diagram illustrating an exemplary spectral calibration flow according to some aspects. The first step of the calibration flow is to measure different reference materials interferograms (I_{RM}) in addition to a narrowband light interferogram (I_{filter}) verses a capacitance signal recorded with time. This capacitance signal is obtained using a capacitive sensing circuit (e.g., capacitive sensing circuit 120, shown in FIG. 1), synchronized with the current narrowband signal (I_{filter}) received at the photo detector of the spectral sensor. The narrowband light interferogram may be obtained, for example, using an external light source and optical bandpass filter at the desired wavelength to be used for calibration, a single-frequency laser at the desired wavelength, or a filtered laser/LED/SLED (e.g., a laser, together with an optical bandpass filter).

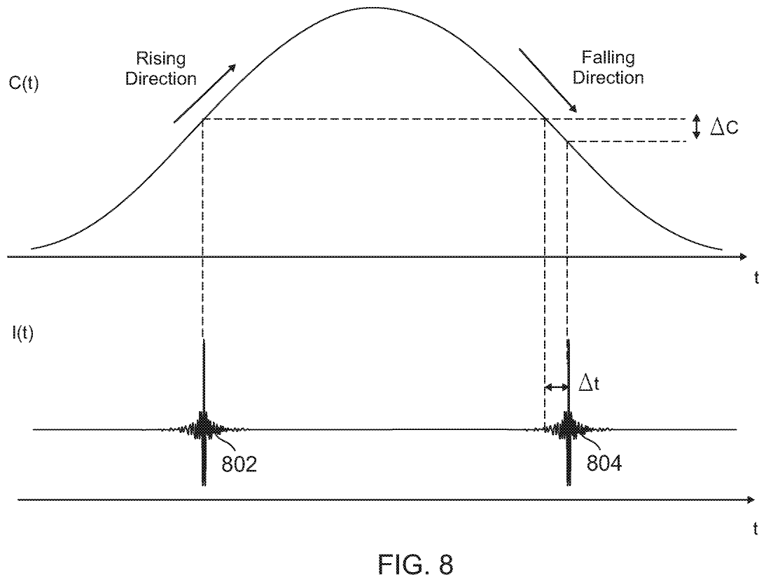

In addition, a white light interferogram measurement (I_{white}) can be recorded for both directions of mirror displacement across the travel range of the MEMS interferometer, as illustrated in FIG. 8. In addition, a capacitance signal versus time (C(t)) and a corresponding interferogram current signal versus time (I(t)) of the white light interferogram can be captured. In various aspects, the delay (Δt) between the capacitance signal (C(t)) and the corresponding interferogram current signal (I(t)) of the white light interferogram (I_{white}) can then be minimized by aligning the two white light interferogram bursts 802 and 804 of I(t) to be averaged properly afterwards. For example, a difference in capacitance values (ΔC) at the peaks of the interferogram bursts 802 and 804 for the rising and falling directions of the moveable mirror can be calculated and the corresponding delay (Δt) between the measured interferogram bursts 802 and 804 and expected interferogram bursts (e.g., based on ΔC) can then be determined. Then, through an iterative process, the delay (Δt) between the interferogram current signal (I(t)) and the capacitance signal (C(t)) may be minimized.

In an example, the two white light interferogram bursts 802 and 804 shown in FIG. 8 within I(t) can be correlated with the corresponding capacitance values of the rising direction (C_{rising}) and falling direction (C_{falling}) of the capacitance signal (C(t)). Since the capacitance values C_{rising} and C_{falling} at each of the interferogram bursts 802 and 804 should be equal (e.g., interferogram burst locations for both directions must occur at the same capacitance), ΔC can be calculated as ΔC=C_{rising}−C_{falling}, where C_{rising} is the capacitance value corresponding to the white light interferogram burst 802 for the rising direction and C_{falling} is the capacitance value corresponding to the white light interferogram burst 804 for the falling direction. From ΔC, the delay (Δt) between the actual time of the interferogram bursts 802 and 804 and the expected time (e.g., based on ΔC) of the interferogram bursts can be minimized.

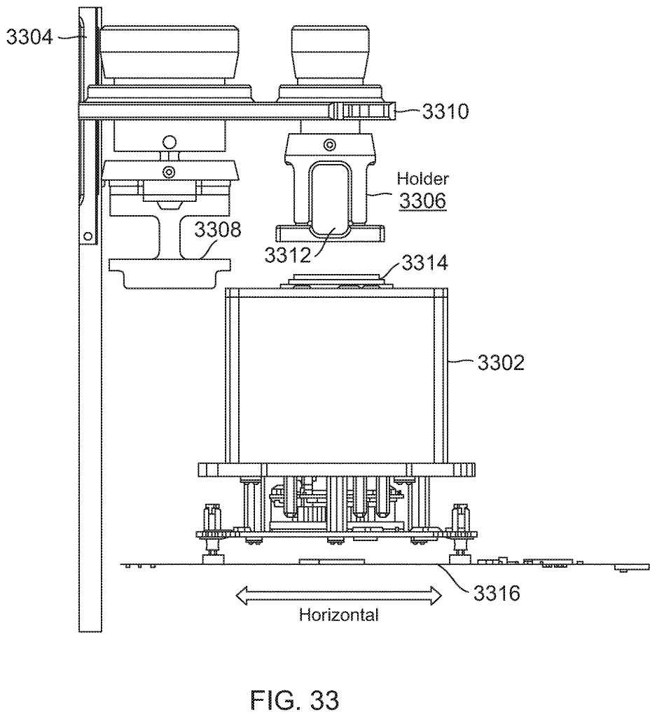

For example, with reference to FIG. 34, an exemplary process 3400 for delay compensation of a diffuse-reflection spectral sensor is illustrated. At block 3402, a delay value between a capacitance signal and an interferogram current signal (C(t) and I(t)) can be initialized (set) to an initial delay value (e.g., within an electronics digital register). At 3404, a capacitance signal versus time and a corresponding interferogram current signal versus time of a white light interferogram recorded for both directions of mirror displacement across the travel range of the moveable mirror can be captured. At block 3406, the white light interferogram bursts within I(t) can be identified and a calculated capacitance difference value (ΔC) and calculated delay value (Δt) based on the interferogram bursts (e.g., between the falling and rising peaks of the interferogram bursts) can be extracted. For example, the calculated capacitance difference value (ΔC) can be calculated as the difference in capacitance values between the peaks of the interferogram bursts for the falling and rising directions of the moveable mirror and then the corresponding calculated delay value Δt may be calculated based on the interferogram current signal and ΔC. At block 3408, the calculated values (ΔC and Δt) are compared to a threshold. For example, the threshold may be zero or approximately equal to 0. If ΔC or Δt is equal to or below the threshold (Y branch of block 3408), the process ends. However, if either ΔC or Δt is above the threshold (N branch of block 3408), at block 3410, the delay value is adjusted in the digital register and the process repeats at block 3404 until the delay between the interferogram current signal (of the white light interferogram) and the corresponding capacitance signal is minimized. The delay value can then be used to prevent distortion of a subsequently obtained interferogram measurement (e.g., the narrowband interferogram (I_{filter}) or any other sample or background measurement) in which the two interferograms of the rising and falling directions (e.g., the rising interferogram and the falling interferogram) versus capacitance are extracted and then averaged.

Referring again to FIG. 7, a C2X relation (capacitance to OPD relation) 702 can then be extracted using the narrowband light interferogram signal I_{filter} versus capacitance after compensating for the delay (Δt) based on the delay compensation using white light interferogram bursts, as discussed above. The C2X relation 702 can then be stored on the spectral device/sensor processor flash memory or any storage chips/devices to be retrieved and used later. As indicated above, the zero OPD position can be determined from the white light interferogram burst position after delay compensation.

Once the C2X 702 is extracted, the spectral calibration flow can continue by extracting the self-apodization 704 and compensating for the self-apodization. Self-apodization may occur, for example, due to light diffraction mismatches between the two interferometer arms during the mirror movement of a MEMS interferometer, causing a decay in the interference visibility across OPD. For example, imperfect light collimation causes beam divergence, making the effective OPD vary with the angle of incidence. In an example, if the optics that collect the light from the sample and direct it into the interferometer are decentered or tilted, this will affect the interference, where the mirrors will be illuminated partially which will affect the interferogram envelope. As another example, if the optics that collect the light from the interferometer and direct it into the detector are decentered or tilted, it makes the detector collect signal form a shifted position of the beam splitter, which will cause changes in the interferogram envelope. In addition, internal manufacturing errors in the interferogram can also affect the interferogram envelope. The effect of all of these errors results in self-apodization, which refers to a loss of coherence and reduced fringe visibility, particularly at high OPDs. Self-apodization degrades the interferogram envelope, impairing both spectral resolution (broadening lines) and photometric accuracy (introducing systematic errors). Addressing the deleterious effects of self-apodization is paramount for realizing high-performance compact and MEMS-based FTIR spectrometers.

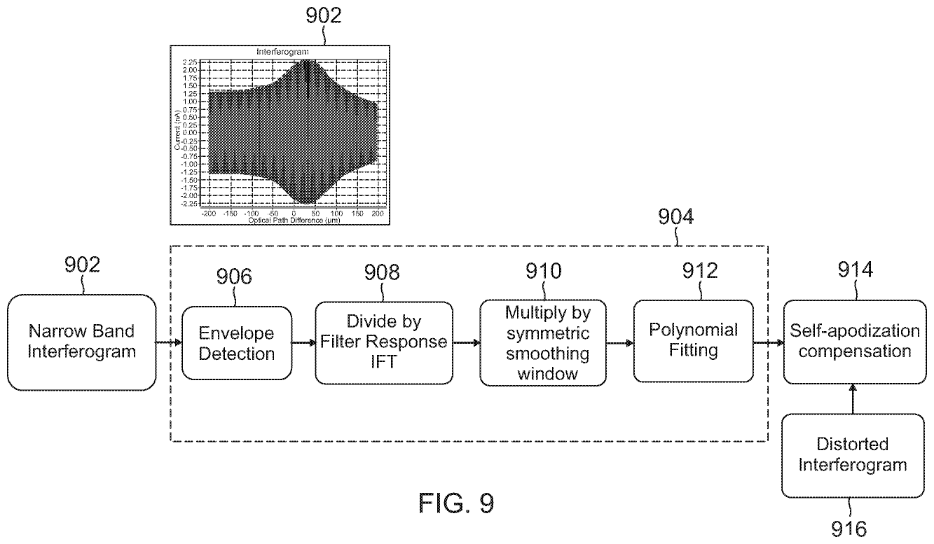

FIG. 9 is a flow diagram illustrating an example flow of self-apodization extraction and compensation according to some aspects. In the example shown in FIG. 9, the divergence-induced modulation across the IR spectrum is experimentally characterized using an envelope extraction technique based on the Hilbert transform. For example, a narrowband interferogram 902 (e.g., an interferogram acquired with a narrowband light source and/or optical bandpass filter), such as I_{filter} shown in FIG. 7, can be input to a self-apodization pipeline 904. In the pipeline 904, envelope detection 906 is initially performed using a Hilbert transform to extract the upper boundary of the decayed interferogram 902. To isolate the pure self-apodization effect, the pipeline 904 then provides the extracted envelope to a division block 908 to remove the known characteristics of the filter by dividing the extracted envelope by the Fourier transform of the bandpass filter's response. In some examples, the division block 908 can be bypassed if the filter linewidth is much narrower than the resolution of the spectral sensor. The resulting self-apodization curve is then mathematically inverted (e.g., as an IFT) and passed through a smoothing block 910 to generate an optimized self-apodization compensation (SAC) envelope.

The optimized SAC envelope can then be input to a polynomial fitting block 912 to fit the optimized SAC envelope to a polynomial of high order and the resulting final SAC envelope can be saved digitally on the spectral sensor memory (e.g., as a self-apodization calibration parameter within the calibration data 218 shown in FIG. 2). Self-apodization compensation 914 can then be performed on a raw, distorted interferogram 916 obtained, for example, during sample measurement of a SUT, by multiplying the final SAC envelope stored on the spectral sensor with the distorted interferogram to restore interferogram symmetry and uniform fringe visibility, suppressing the spectral ripple and photometric distortion caused by the initial beam divergence.

In some examples, the self-apodization envelope can be extracted using deconvolution between the measured spectrum of the spectral sensor and a reference spectrum of the desired shape. For example, the interferogram equation can be represented as:

I(x)=∫V(x)S(v)cos(2πwvx)dv

where v is the wavenumber, x is the optical path difference, V(x) is the self-apodization envelope, I(x) is the interferogram signal of the measurement of the sample, and S(v) is the input sample spectrum. The sample spectrum of the interferogram signal can be calculated using:

B(v)=∫I(x)exp(−j2πvx)dx=∫∫V(x)S(k)cos(2πkx)exp(−j2πvx)dk dx

From Fourier transform properties, multiplication in one domain leads to convolution in the other domain:

Sₘ(v)=FT[V(x)]⊗S(v)

where Sₘ(v) is the measured spectrum using the spectral sensor under test (e.g., the unit under test), and S(v) is the desired spectrum using a reference unit. To correct the self apodization envelope, multiplication by a window that is the reciprocal of the self apodization envelope can be performed, which leads to convolution in the wavenumber domain as follows:

S_{corr}(v)=Cᵥ(v)⊗FT[V(x)]⊗S(v)

where Cᵥ is the correction window FT for self-apodization, S_{corr}(v) is the corrected spectrum after compensation of self-apodization,

$$IFT [ C ( v ) ] = \frac{1}{V ( x )} ,$$

$$V ( x ) = \frac{IFT [ {S}_{m} ( v ) ]}{IFT [ S ( v ) ]} , and$$

$${C}_{v} ( v ) = FT [ \frac{1}{V ( x )} ] = FT [ \frac{IFT [ S ( v ) ]}{IFT [ {S}_{m} ( v ) ]} ] .$$

It is noted that extracted envelopes vary from unit to unit which requires self apodization compensation procedure for each unit. It is also noted that for the same unit and for the same configuration, the extracted self-apodization envelope may vary across wavelength. This may lead to residual errors at different wavelengths far from the wavelength used for calibration.

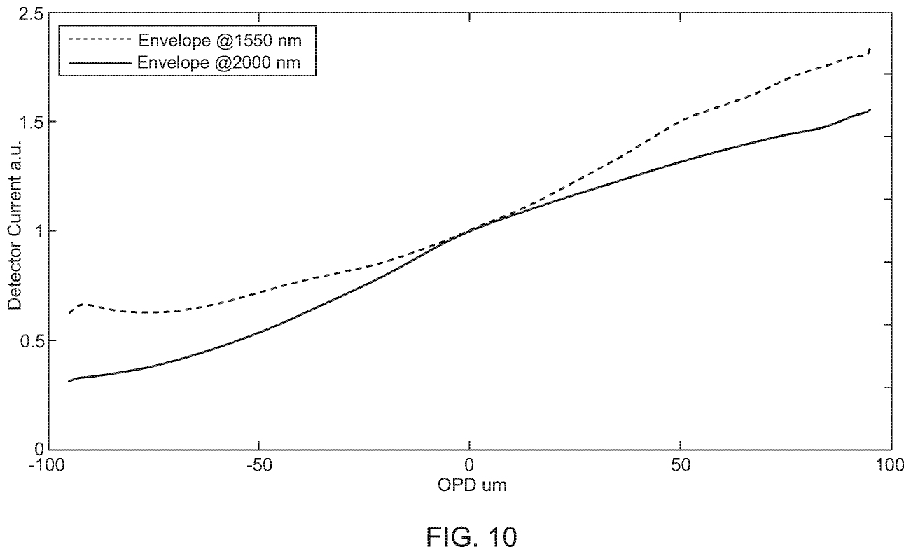

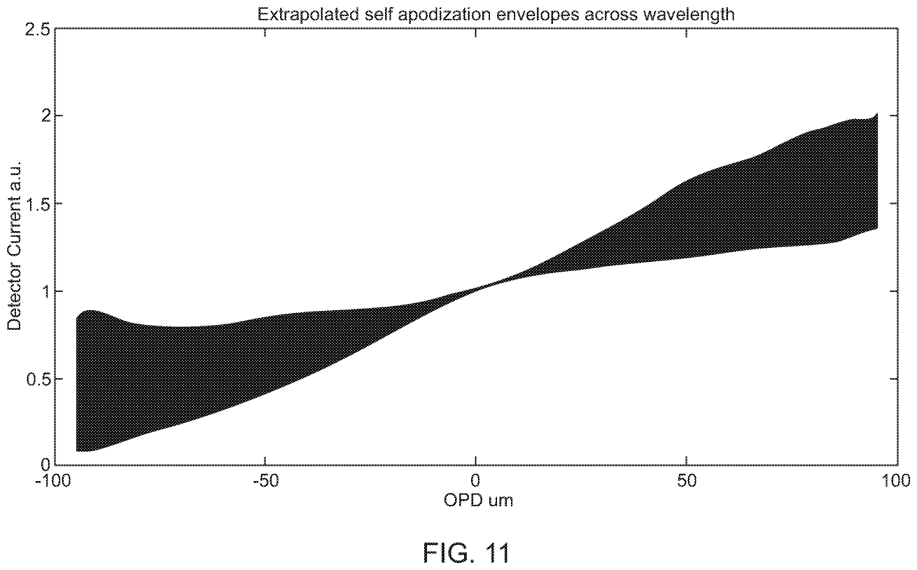

Therefore, in some examples, to extract the self-apodization envelope across wavelength, a reflection-mode calibration configuration can be employed with two optical filters at, for example, 1550 nm and 2000 nm, as shown in FIG. 10, and interpolation in between the optical filter wavelengths and outside their range may be performed, as shown in FIG. 11, to produce a closer estimate of the self-apodization envelope's variation (e.g., a self-apodization envelope matrix) across an optical path difference (OPD) and wavelength range of interest. In this case, the corrected spectrum B_{c} can be extracted from:

B_{c}(v)=∫C(x,v)I(x) exp(−j2πvx)dx

where C(x, v) is the self-apodization compensation matrix across wavenumber and OPD. In this example, C(x, v) can be extracted using different bandpass filters (BPFs) across the range and interpolate in-between the BPFs.

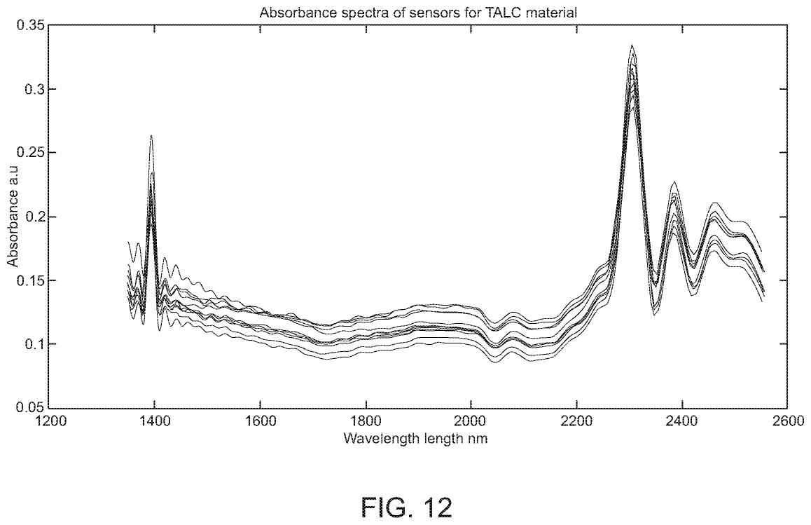

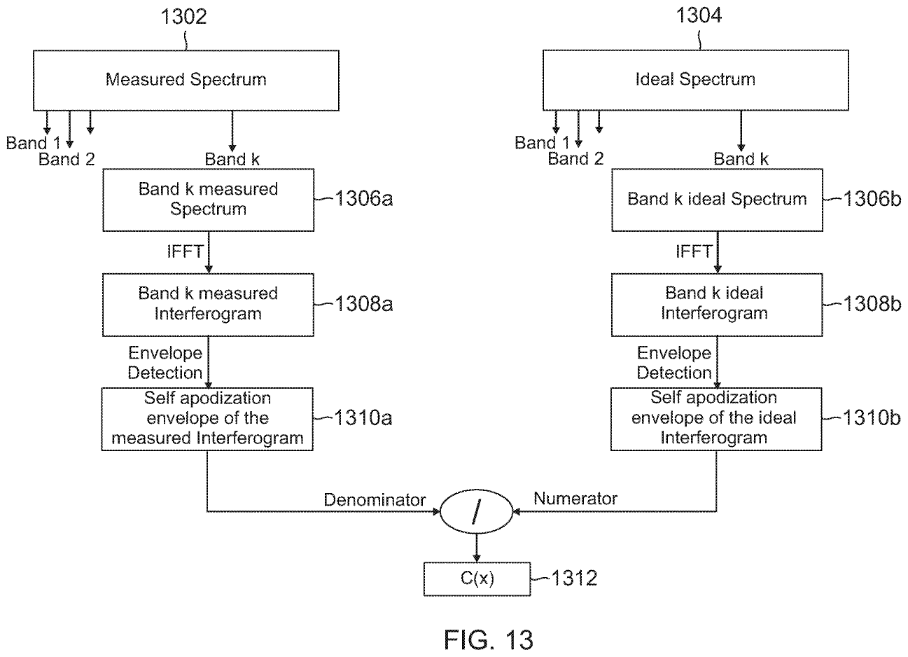

In other examples, the self-apodization envelope may be extracted across wavelengths from narrow bands of the Talc absorbance spectrum, as shown in FIG. 12, using a deconvolution method based on Fourier transform. Referring now to FIG. 13, given a measured reference material reading of a spectral sensor (measured spectrum 1302) and another reference material reading (ideal spectrum 1304) of an ideal unit (reference spectral sensor or average of large set), both the measured spectrum and the ideal spectrum can be split into N segments (e.g., Band 1, Band 2, . . . , Band k) with each band containing spectral lines. A respective inverse Fourier transform (IFFT) operation can then be applied to the chosen bands 1306a and 1306b of the measured and ideal units, and the envelopes of both interferograms 1308a and 1308b can be detected. The extracted self-apodization envelope 1310b of the ideal unit can then be divided by the self-apodization envelope 1310a of the measured unit to obtain the correction envelope C(x, v) 1312. The process can be repeated for the desired number of segments based on the accuracy needed. Linear interpolation can then be performed to deduce correction envelopes at bands not chosen in the process or the regions with no obvious features.

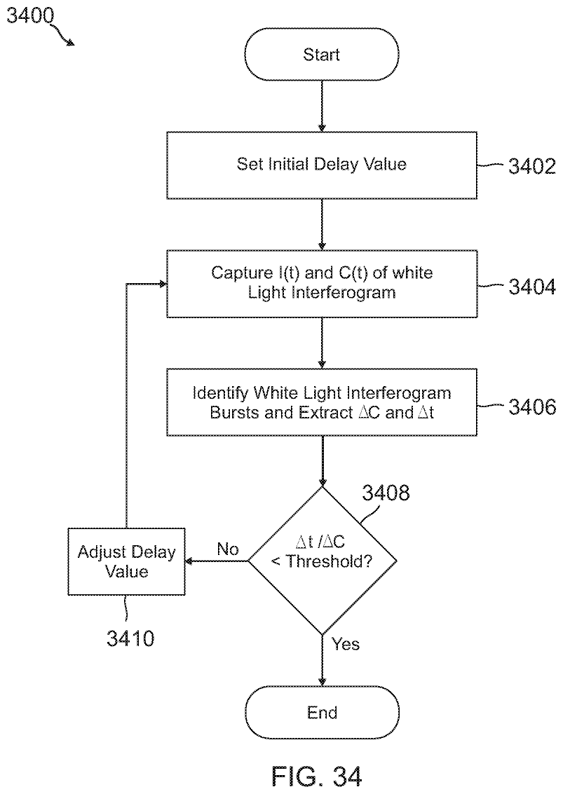

FIG. 35 is a diagram illustrating an exemplary process 3500 for self-apodization compensation according to some aspects. At block 3502, a narrowband interferogram signal can be captured by a diffuse-reflection spectral sensor that includes a MEMS interferometer having a moveable mirror and a fixed mirror. In some examples, the narrowband interferogram signal may be captured based on an optical bandpass filter inserted into an optical path of the diffuse-reflection spectral sensor. At block 3504, an envelope of the narrowband interferogram signal can be extracted (e.g., using an envelope extraction mechanism, such as a Hilbert transform). At block 3506, a self-apodization calibration function can be produced based on the extracted envelope to compensate for self-apodization resulting from light diffraction during movement of the moveable mirror.

In some examples, the extracted envelope can be divided by a Fourier transform of a response of the optical bandpass filter to produce a self-apodization curve. The self-apodization curve can then be inverted and smoothed to generate an optimized self-apodization compensation envelope. The optimized self-apodization compensation envelope can then be fitted to a high order polynomial to produce the self-apodization calibration function. In some examples, the narrowband interferogram signal includes a first narrowband interferogram signal associated with a first optical bandpass filter and a second narrowband interferogram signal associated with a second optical bandpass filter. In this example, a self-apodization envelope matrix across an optical path difference (OPD) of the MEMS interferometer and wavelength can be extracted by interpolating between and extrapolating outside a respective wavelength range of each of the first optical bandpass filter and the second optical bandpass filter across a wavelength range of interest. The self-apodization envelope matrix can then be used to produce the self-apodization calibration function. In some examples, self-apodization can be extended across the spectral range through a windowed Fourier transform.

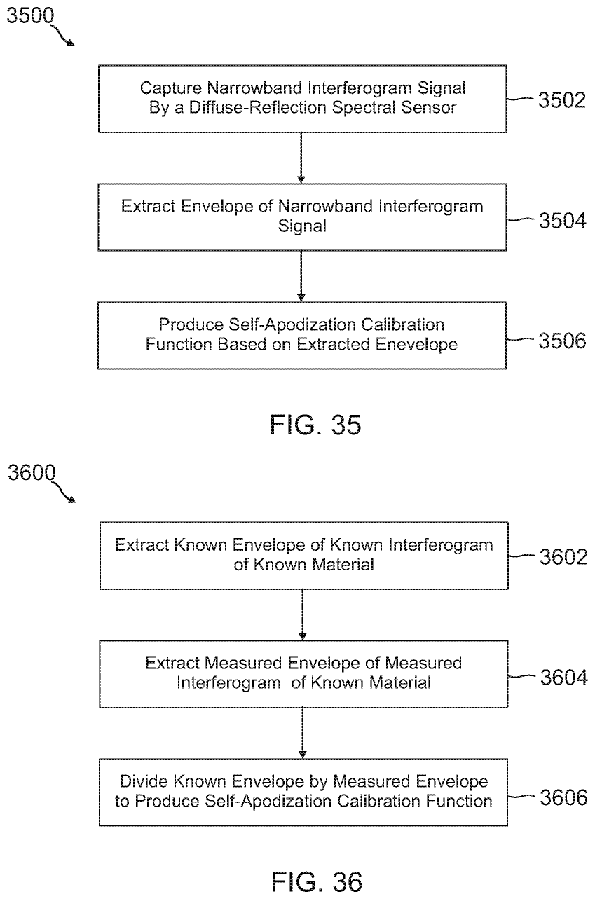

FIG. 36 is a diagram illustrating another exemplary process 3600 for self-apodization compensation according to some aspects. At block 3602, a known envelope of a known interferogram of a known material can be extracted at one or more wavelength ranges (e.g., using a Hilbert transform or other envelope extraction mechanism). At block 3604, a measured envelope of a measured interferogram signal obtained by a diffuse-reflection spectral sensor of the known material at the one or more wavelength ranges can also be extracted (e.g., using a Hilbert transform or other envelope extraction mechanism). For example, the diffuse-reflection spectral sensor can include a MEMS interferometer having a moveable mirror and a fixed mirror. In addition, the measured interferogram signal may be obtained based on the known material being placed on an optical window of the diffuse-reflection spectral sensor. At block 3606, the known envelope can then be divided by the measured envelope to produce a self-apodization calibration function that is configured to compensate for self-apodization resulting from light diffraction during movement of the moveable mirror.

Referring again to FIG. 7, after self-apodization extraction 704, the final step in the spectral calibration flow is wavelength correction 706. Wavelength correction 706 can be performed using white light and reference material power spectral density PSD readings, which are calculated after applying Fast Fourier Transform (FFT) to the measured interferogram signals I_{white} and I_{RM}. The reference material PSD is then divided by the white light PSD to obtain the absorbance spectrum. The reference material's peaks are then detected and corrected with respect to their known positions using, for example, multiple linear regression based on least squares to produce a wavelength correction calibration parameter that can be stored together with the C2X relation and self-apodization calibration parameter as calibration data (e.g., calibration data 218 shown in FIG. 2) within, for example, within the sensor memory.

In some examples, two reference materials, polystyrene film, which has well-defined absorption peaks used to align the wavelength axis in the near infrared (NIR) range, and MRC 910-1920x, which is derived from the standard SRM 1920a (a mixture of rare-earth oxides: dysprosium, erbium, and holmium) contains additional peaks (including Talc) that extend calibration coverage up to 2550 nm and has several stable absorption peaks. To correct wavelength errors, both materials can be measured using the spectral sensor, and the observed peak positions (e.g., 10 total peaks) can be compared to their known reference positions. A second-order polynomial function can then be fitted to map the measured wavenumber v axis to the reference axis, minimizing errors, such that the corrected wavenumber axis v_{corr} is given by:

v_{corr}=a₁v²+a₂v+a₃

where the polynomial coefficients a₁, a₂ and a₃ are optimized to best align the measured and reference peak positions. The selected polynomial is then applied to correct the wavelength axis of new measurements.

To utilize those peaks positions to decrease the magnitude of wavelength errors in measurements taken by another spectral sensor on the production line, measurements of the same reference material may be taken by the other spectral sensor (referred to herein as an instrument). The objective is to bring the detected peaks using the instrument to the reference chosen peaks by obtaining the polynomial that best fits the detected peaks and if multiplied by the wavenumber axis currently used by this polynomial, it should minimize the wavelength errors of the used peaks in correction. In some examples, peaks that cover the whole range of interest can be picked if it is required to correct wavelength errors across the whole range and not just improving the variations in a certain band or single wavelength.

The objective then is to search for a function such that if multiplied by the measured peaks of the instruction, it will bring the error between the instrument measured peaks and reference peaks to a minimum. For example, if 8 peaks are chosen from the reference material, the reference peaks can be represented as C(8*1), and the measured peaks of the reference material using the spectral sensor can be represented as A. Therefore, by the definition of C(8*1)=A*B, the following equations can be produced:

C₁=A₁*B

C₂=A₂*B

. . .

C₈=A₈*B

As a result, there are now 8 equations which limit the maximum number of unknowns to be eight, thereby limiting the maximum polynomial to the seventh order polynomial. To search for a second order polynomial to be used in correction:

y=b₂x²+b₁x+b₀,

with a

$$correction function = B ( 3 * 1 ) = [ \begin{matrix}{b}_{2} \\ {b}_{1} \\ {b}_{0}\end{matrix} ] ,$$

then:

C(8*1)=A(m*n)*B(3*1).

In order to perform this matrix multiplication, dimensions of A should be (8*3), making m=8 and n=3. Therefore:

C(8*1)=A(8*3)*B(3*1)

which results in:

$${C}_{1} = {b}_{0} + {b}_{1} {A}_{1} + {b}_{2} {A}_{1}^{2}$$

$${C}_{2} = {b}_{0} + {b}_{1} {A}_{2} + {b}_{2} {A}_{2}^{2}$$

$$…$$

$${C}_{8} = {b}_{0} + {b}_{1} {A}_{8} + {b}_{2} {A}_{8}^{2}$$

To obtain the correction function

$$B = \frac{C}{A} = {CA}^{- 1} ,$$

a problem may arise from a matrix operation perspective if the A matrix is not square, thus the inverse may not be determined. Therefore, the pseudo-inverse (using a least squares approach) may be used instead of a normal inverse, as follows:

$${A}^{- 1} = {[ {A}^{′} ( 3 * 8 ) * A ( 8 - 3 ]}^{- 1} * {A}^{- 1} ( 3 * 8 )$$

$$= {( 3 * 3 )}^{- 1} * ( 3 * 8 )$$

$$= ( 3 * 3 ) * ( 3 * 8 )$$

$$= ( 3 * 8 )$$

### Thus:

A⁻¹(3*8)=[A′(3*8)*A(8*3)]⁻¹*A′(3*8)

B=A⁻¹(3*8)*C(8*1)

B is then of dimensions 3*1=b₂x²+b₁x+b₀ second order polynomial. The residual error ε after fitting to the chosen polynomial may then be defined as:

ε(8*1)=C(8*1)−A(8*3)*B(3*1).

It should be noted that as the order of the polynomial is increased, the wavelength error variations across a test sample of spectral sensors is minimized. This is proven to be true for the reference sample and other materials that share the same peaks with the reference. However, if polynomial order is increased more than required, the correction polynomial will be over fitted to the reference material and the errors will be still large with other materials. An improvement can be made by entering both sets of peaks, the MRC910-1920x material (8 peaks) and the polystyrene material (2 peaks) in order to compromise benefits of applying correction using both materials and cover the whole range.

The correction polynomial of the wavelength axis crucially affects the wavelength errors. Low polynomial orders may be an insufficient option to mitigate wavelength errors. On the contrary side, picking higher order polynomial could give very good results for certain reference material (e.g., MRC and polystyrene) measurements obtained by the instrument but at the same time, it may lead to over fit the peaks of both materials, their peaks used in the correction, while making wavelength errors to increase in other materials.

Therefore, validation of the correction order can be performed in four different stages to choose the best correction polynomial order: (1) validation of the wavelength errors of the same material's peaks used in correction; (2) validation of the wavelength errors of the same materials' but different peaks other than the peaks used in correction; (3) validation of the wavelength errors of different materials peaks other than MRC and poly (e.g. Powder material set); and (4) validation on spectroscopy prediction models before and after using wavelength correction (e.g. Starch model). The first validation made is by checking wavelength errors across the same peaks incorporated in the multiple linear regression function. A set of spectral sensors can be used to evaluate the improvement. The second layer of validation can be performed on the whole peaks either used or not used in the correction scheme but of the same reference materials or similar materials. To quantify the process of choosing the order, the normalized sum of the maximum error across all the spectral sensors for all peaks to cover the range and of some materials is calculated. The metric of normalized sum of the maximum wavelength error is sought to be minimized on average across all materials. In the next validation stage, other validation materials, such as a set of talc-starch powder, can be used to avoid an over fitting case resulting from choosing a high order that best suits the chosen peaks but fails to generalize to other materials. As a final stage of validation, investigation of spectroscopic prediction models parameters (bias, RMSE and SEP) before and after using the correction function can be performed. Wavelength errors will cause those model parameters to worsen. Therefore, tracking those parameters will give an indication of how using this correction function improves the model parameters.

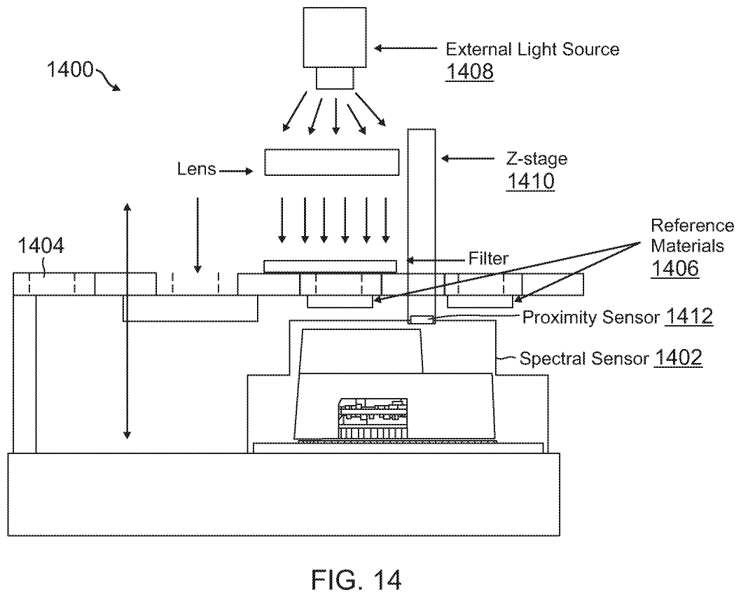

FIG. 14 is a diagram illustrating an example of an apparatus configured for testing after spectral calibration according to some aspects. The apparatus 1400 corresponds to the same apparatus that performed the calibration of a spectral sensor 1402 (e.g., as shown in FIG. 6); however, the testing process involves measuring the reflection spectra of certain reference materials with known peaks. This can be performed automatically after the calibration process is finished by moving the Y-stage stepper motor/slider 1404 to position a reference material placed within, for example, a socket/slot of the Y-stage slider 1404 above the spectral sensor 1402 (e.g., within the optical path of the spectral sensor 1402). In addition, output light from an external light source 1408 can be blocked (e.g., the external light source lamp(s) can be turned off), while the Z-stage motor 1410 moves down to touch the spectral sensor 1402 (e.g., the reference material is placed on the optical window of the spectral sensor 1402). A proximity sensor 1412 attached to the Z-stage motor 1410 can be used to detect the spectral sensor 1402, thus ensuring that the distance between the reference material 1406 and the spectral sensor 1402 is always constant for different spectral sensors. The number of reference materials 1406 to be used are limited only by the available slots in the Y-stage motor 1404. By doing so, calibration and testing of the spectrometer is fully automated, and as a result, the apparatus 1400 functions as an Automated Testing Equipment (ATE) for miniaturized spectrometers.

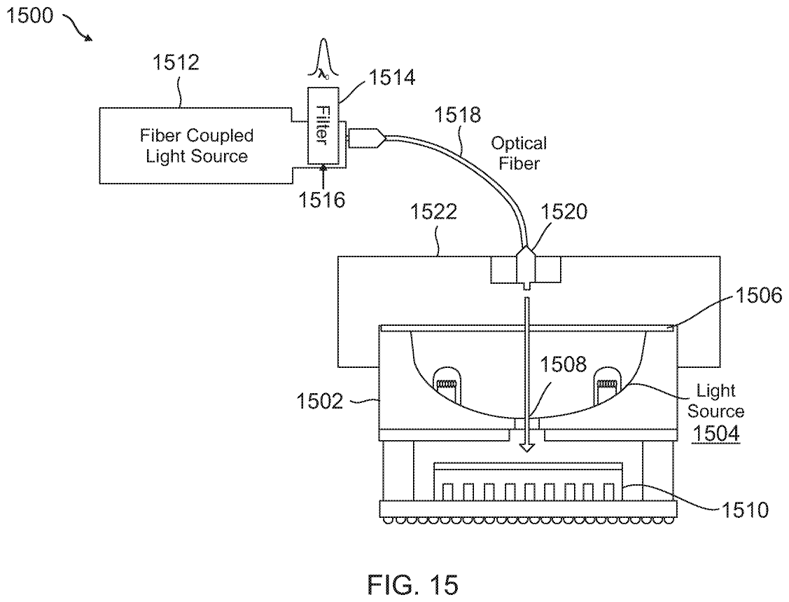

FIG. 15 is a diagram illustrating another example of an apparatus configured for automated spectral calibration according to some aspects. The apparatus 1500 (e.g., calibration apparatus) includes a diffuse-reflection spectral sensor 1502 configured to operate in a diffuse-reflectance mode. In some examples, the diffuse-reflection spectral sensor 1502 may also operate in other transmission and/or reflection modes. The spectral sensor 1502 includes a light source 1504 (e.g., an optical head) configured to generate input light and to direct the input light towards an optical window 1506 on which a sample-under-test (SUT), not shown, may be placed. The input light from the optical head 1504 can be diffusely reflected from the SUT and the diffusely reflected light is then directed via an optical aperture 1508 towards a light modulation chip 1510 including a light modulator/detector (e.g., a MEMS based spectrometer). The light modulation chip 1510 can further include an on-chip processor (not shown) configured to process an interferogram signal produced by the detector.

In the example shown in FIG. 15, the apparatus 1500 can include an external light source 1512 including a slot 1516 to insert an optical filter 1514 in the light path for single wavelength calibration. In addition, the output light from the external light source 1512 is coupled to an optical fiber 1518 that couples light at its other end to the spectral sensor 1502 under calibration. A cover 1522 with an opening 1520 for fiber ferrule insertion can be placed onto the optical head 1504 of the sensor 1502 to align the optical fiber 1518 with the light modulation chip/optical core module OCM chip 1510 to calibrate, for example, the mirror positioning of the light modulator.

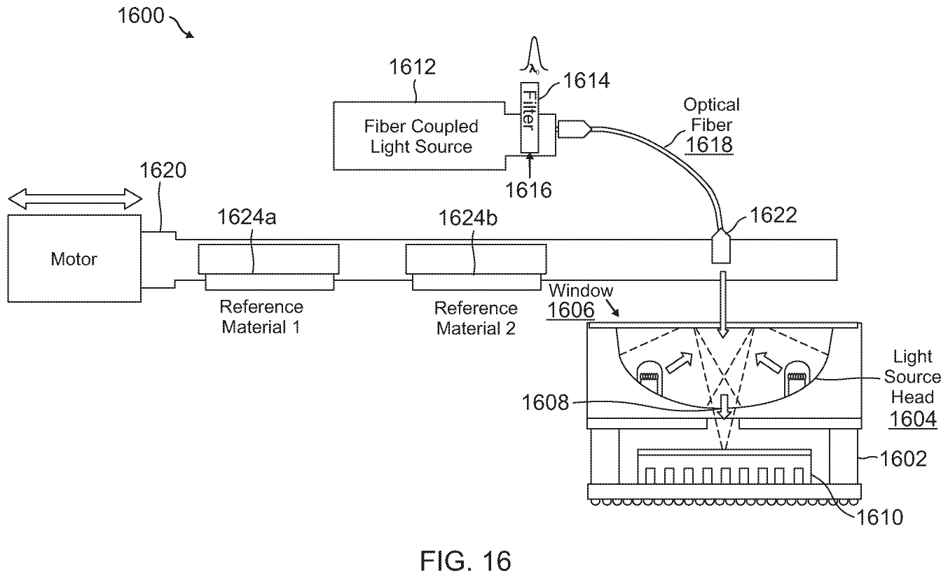

FIG. 16 is a diagram illustrating another example of an apparatus configured for automated spectral calibration according to some aspects. The apparatus 1600 (e.g., calibration apparatus) includes a diffuse-reflection spectral sensor 1602 configured to operate in a diffuse-reflectance mode. In some examples, the diffuse-reflection spectral sensor 1602 may also operate in other transmission and/or reflection modes. The spectral sensor 1602 includes a light source 1604 (e.g., an optical head) configured to generate input light and to direct the input light towards an optical window 1606 on which a sample-under-test (SUT), not shown, may be placed. The input light from the optical head 1604 can be diffusely reflected from the SUT and the diffusely reflected light is then directed via an optical aperture 1608 towards a light modulation chip/spectral optical core module (OCM) 1610 including a light modulator/detector (e.g., a MEMS based spectrometer). The light modulation chip 1610 can further include an on-chip processor (not shown) configured to process an interferogram signal produced by the detector.

In the example shown in FIG. 16, the apparatus 1600 can include an external light source 1612 including a slot 1616 to insert an optical filter 1614 in the light path for single wavelength calibration. In addition, the output light from the external light source 1612 is coupled to an optical fiber 1618 that couples light at its other end to the spectral sensor 1602 under calibration. The apparatus 1600 is fully automated using a Y-stage motor 1620 that can be controlled by a calibration control and processing unit (not shown) during a calibration flow to obtain calibration data to calibrate the spectral sensor 1602. The Y-stage motor 1620 can include a plurality of slots/sockets configured to hold optical elements, including, for example, lenses, reference materials, optical filters, optical windows, optical diffusers, fiber couplers, etc. For example, one of the sockets may be configured to hold a fiber coupler 1622 configured for fiber insertion of the optical fiber 1618. Other sockets may include, for example, reference materials 1624a and 1624b. The Y-stage motor/slider 1620 is configured to control and move the sockets laterally (e.g., in the y-direction) to position one of the sockets above the spectral sensor 1602 based on a current measurement being performed by the automated spectral calibration apparatus 1600.

For example, during a calibration flow, wavelength accuracy and full width at half maximum of filter 1614 measurement can be adjusted and minimized using reference material 1624a/1624b measurement and calibration source reading with the optical filter 1614 respectively. Reference material absorption lines can be detected and then corrected with respect to their correct values to minimize wavelength errors across spectral sensor units. This requires taking measurements of background and reference material samples to evaluate errors and then correct them. In addition, a calibration source with a single wavelength filter 1614 reading can be recorded to be used for calibration and minimization of variations in measured resolution of filter reading across all spectral sensor units. To achieve this target in an efficient way, the motorized Y-stage 1620 can include two reference materials 1624a and 1624b (Reference Materials 1 and 2) and a PTFE tile/Spectralon (not shown) or other optical diffuser that couples and diffuses light from the optical fiber 1618 to the spectral sensor 1602. The Y-stage slider 1620 can be configured to move sequentially to position PTFE tile/Spectralon/optical filter 1614 then Reference Material 1 1624a above the spectral sensor 1602 for a first reference material reading and the same flow can then be repeated with Reference Material 2 1624b and filter reading. Such a configuration reduces the need for inserting and removing the reference material and the filter 1614/optical diffuser multiple times, and therefore reduces calibration time. In some examples, two lenses may be added before and after the optical 1614 filter for light collimation, reduction of stray rays and increase of the coupled power to the OCM chip, as illustrated in FIG. 6.

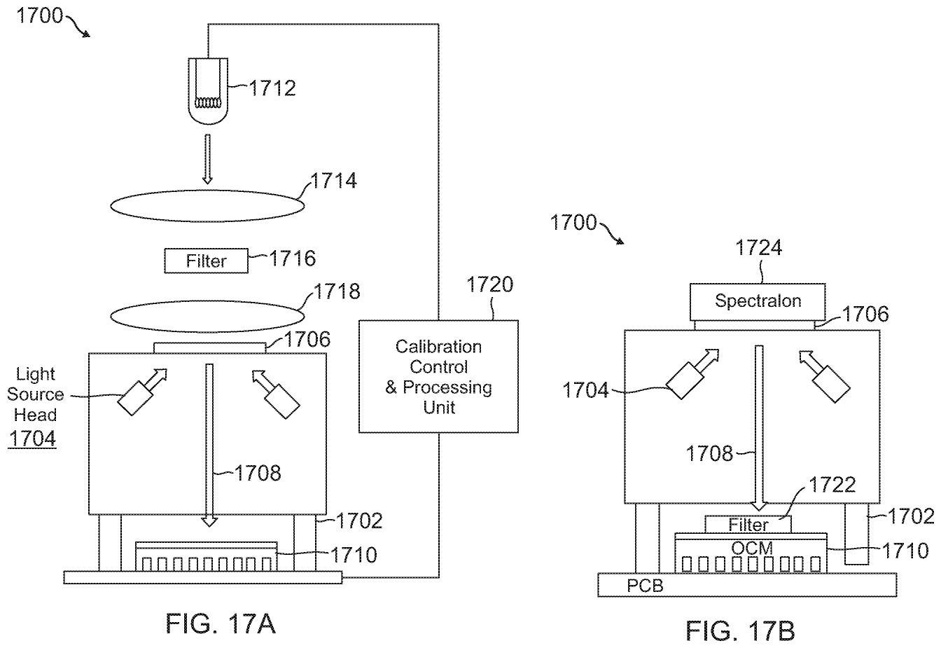

FIGS. 17A and 17B are diagrams illustrating other examples of an apparatus configured for automated spectral calibration according to some aspects. The apparatus 1700 (e.g., calibration apparatus) includes a diffuse-reflection spectral sensor 1702 configured to operate in a diffuse-reflectance mode. In some examples, the diffuse-reflection spectral sensor 1702 may also operate in other transmission and/or reflection modes. The spectral sensor 1702 includes a light source 1704 (e.g., an optical head) configured to generate input light and to direct the input light towards an optical window 1706 on which a sample-under-test (SUT), not shown, may be placed. The input light from the optical head 1704 can be diffusely reflected from the SUT and the diffusely reflected light is then directed via an optical aperture 1708 towards a light modulation chip/spectral optical core module (OCM) 1710 including a light modulator/detector (e.g., a MEMS based spectrometer). The light modulation chip 1710 can further include an on-chip processor (not shown) configured to process an interferogram signal produced by the detector.

As described herein, two configurations can be used for spectral sensor calibration. In the first configuration, as shown previously, and further illustrated in FIG. 17A, output light from an external light source 1712 is passed through a lens 1714 for collimation then to an optical filter 1716 then to another lens 1718 and then to the OCM chip 1710 of spectral sensor 1702 intended to be calibrated. The resulting interferogram may be processed by a calibration control and processing unit 1720 to produce calibration data that may be stored on the OCM 1710. In addition, control of the external light source 1712, spectral sensor 1702, and positioning of the lens 1718 within the optical path of the spectral sensor 1702 (e.g., control of a Y-stage motor/stepper/slider) may be performed by the control and processing unit 1720.

The other configuration, as illustrated in FIG. 17B, relies on diffuse-reflected light from a diffuse-reflection reference material 1724, such as PTFE, ceramic, Teflon, etc, which matches the real usage model that depends on diffuse reflectance light collected from the sample. Hence, the second configuration is reflection based and can provide higher accuracy of wavelength and resolution. In the second configuration, IR input light is injected from the light source head 1704 of the spectral sensor 1702 to be reflected using a totally reflective material 1724 in the IR range (Spectralon). Then, the light is passed through the optical filter 1722 and then to the OCM chip 1710. A robotic arm (e.g., which may be part of the Y-stage slider or a separate arm) can be used to insert the filter 1722 above the OCM chip 1710. In addition, the control and processing unit 1720 (not specifically shown in FIG. 17B) can be configured to process the resulting interferogram to produce calibration data that may be stored on the OCM 1710 and can further control the robotic arm to insert the optical filter 1722 within the spectral sensor 1702.

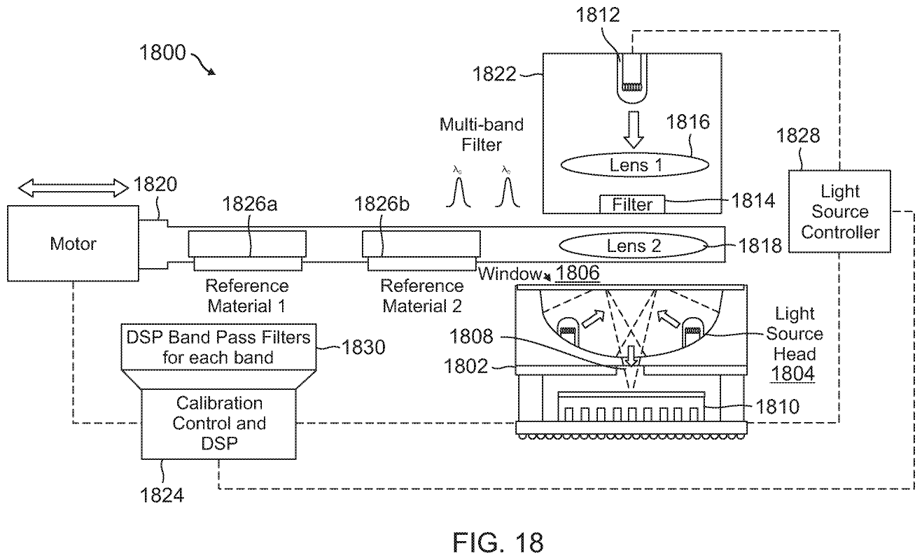

FIG. 18 is a diagram illustrating another example of an apparatus configured for automated spectral calibration according to some aspects. The apparatus 1800 (e.g., calibration apparatus) includes a diffuse-reflection spectral sensor 1802 configured to operate in a diffuse-reflectance mode. In some examples, the diffuse-reflection spectral sensor 1802 may also operate in other transmission and/or reflection modes. The spectral sensor 1802 includes a light source 1804 (e.g., an optical head) configured to generate input light and to direct the input light towards an optical window 1806 on which a sample-under-test (SUT), not shown, may be placed. The input light from the optical head 1804 can be diffusely reflected from the SUT and the diffusely reflected light is then directed via an optical aperture 1808 towards a light modulation chip/spectral optical core module (OCM) 1810 including a light modulator/detector (e.g., a MEMS based spectrometer). The light modulation chip 1810 can further include an on-chip processor (not shown) configured to process an interferogram signal produced by the detector.

In the example shown in FIG. 18, the apparatus 1800 can include an external light source 1812 followed by a narrow band filter (optical narrow bandpass filter) 1814 at the desired wavelength to be used for calibration. Two lenses 1816 and 1818 are used to couple the narrowband light to the MEMS spectrometer (light modulation chip 1810). The apparatus 1800 is fully automated using a Y-stage motor 1820 and a Z-stage motor 1822 that can be controlled by a calibration control and processing DSP 1824 (e.g., control and processing unit) configured to execute, for example, calibration and testing software. In the example shown in FIG. 18, the second lens 1818 is positioned on the Y-stage motor 1820, along with one or more reference materials 1826a and 1826b. In addition, the control and processing unit 1824 is further coupled to a light source controller 1828 configured to control the internal light source head 1804 of the spectral sensor 1802 and the external light source 1812.

In the example shown in FIG. 18, the optical filter 1814 is a multiband filter is used to perform calibration at multiple wavelengths across the range instead of a single wavelength. This configuration can improve wavelength accuracy across the range and reduce residual self apodization errors resulting from self apodization compensation done at single wavelength only. A specific DSP algorithm 1830 executed by the calibration and control DSP 1824 can be applied to digitally isolate each interferogram signal corresponding to each filter band, as shown in FIG. 18.

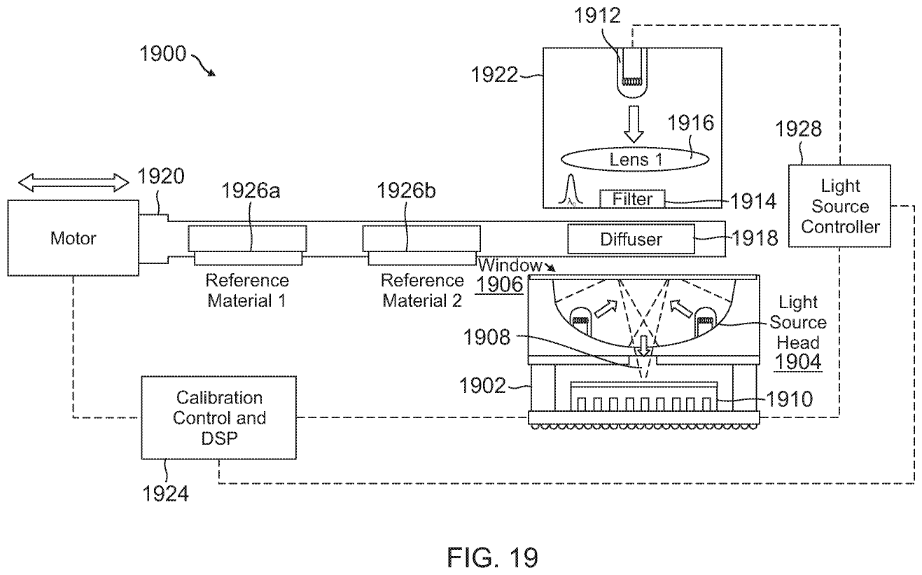

FIG. 19 is a diagram illustrating another example of an apparatus configured for automated spectral calibration according to some aspects. The apparatus 1900 (e.g., calibration apparatus) includes a diffuse-reflection spectral sensor 1902 configured to operate in a diffuse-reflectance mode. In some examples, the diffuse-reflection spectral sensor 1902 may also operate in other transmission and/or reflection modes. The spectral sensor 1902 includes a light source 1904 (e.g., an optical head) configured to generate input light and to direct the input light towards an optical window 1906 on which a sample-under-test (SUT), not shown, may be placed. The input light from the optical head 1904 can be diffusely reflected from the SUT and the diffusely reflected light is then directed via an optical aperture 1908 towards a light modulation chip/spectral optical core module (OCM) 1910 including a light modulator/detector (e.g., a MEMS based spectrometer). The light modulation chip 1910 can further include an on-chip processor (not shown) configured to process an interferogram signal produced by the detector.

In the example shown in FIG. 19, the apparatus 1900 can include an external light source 1912 followed by a narrow band filter (optical narrow bandpass filter) 1914 at the desired wavelength to be used for calibration. A lens 1916 is used to couple the output light from the external light source 1912 to the optical filter 1914 and the resulting narrowband light is coupled to the spectral sensor 1902 via an optical diffuser 1918. Placing the diffuser 1918 after the filter 1914 makes the calibration measurement similar to the case of diffuse reflectance in terms of light spatial coherence and distribution at the spectral sensor input. The diffuser 1918 helps to make laser beams (if used as the external light source 1912) spatially incoherent to match the operation mode of the diffuse-reflection spectral sensor 1902.

The apparatus 1900 is again fully automated using a Y-stage motor 1920 and a Z-stage motor 1922 that can be controlled by a calibration control and processing DSP (e.g., control and processing unit) 1924 configured to execute, for example, calibration and testing software. In the example shown in FIG. 19, the optical diffuser 1918 is positioned on the Y-stage motor 1920, along with one or more reference materials 1926a and 1926b. In addition, the control and processing unit 1924 is further coupled to a light source controller 1928 configured to control the internal light source head 1904 of the spectral sensor 1902 and the external light source 1912. In some examples, active alignment by the Y-stage motor 1920 and Z-stage motor 1922 to adjust the laser position in order to receive the maximum optical power and a normal self apodization envelope according to design can avoid misalignment between the source 1912 and OCM 1910. In some examples, the calibration control and DSP 1924 and light source controller 2028 can be configured to control the number of filaments of the external light source 1912 and/or the internal light source head 1904 by turning on them all, turning them off, or a combination to get the acceptable amount of power at the OCM chip 1910.

Specular reflection of light from spectral sensor window or an extra accessory window used above the sensor, is usually considered as stray light that doesn't represent the sample under analysis, leading to absorbance non-linear errors. Compensating this non-useful signal becomes important when it varies from a spectral sensor to another.

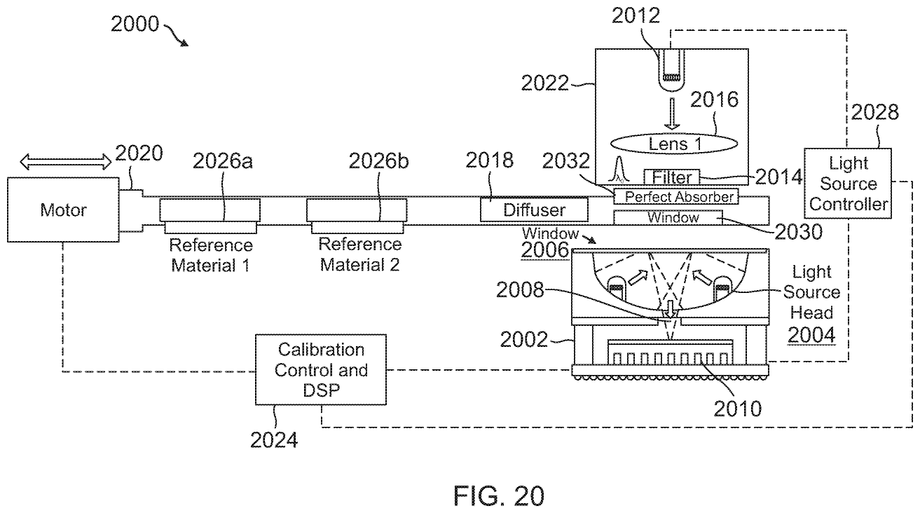

FIG. 20 is a diagram illustrating another example of an apparatus configured for automated spectral calibration and specular back-reflection measurement according to some aspects. The apparatus 2000 (e.g., calibration apparatus) includes a diffuse-reflection spectral sensor 2002 configured to operate in a diffuse-reflectance mode. In some examples, the diffuse-reflection spectral sensor 2002 may also operate in other transmission and/or reflection modes. The spectral sensor 2002 includes a light source 2004 (e.g., an optical head) configured to generate input light and to direct the input light towards an optical window 2006 on which a sample-under-test (SUT), not shown, may be placed. The input light from the optical head 2004 can be diffusely reflected from the SUT and the diffusely reflected light is then directed via an optical aperture 2008 towards a light modulation chip/spectral optical core module (OCM) 2010 including a light modulator/detector (e.g., a MEMS based spectrometer). The light modulation chip 2010 can further include an on-chip processor (not shown) configured to process an interferogram signal produced by the detector.

In the example shown in FIG. 20, the apparatus 2000 can include an external light source 2012 followed by a narrow band filter (optical narrow bandpass filter) 2014 at the desired wavelength to be used for calibration. A lens 2016 is used to couple the output light from the external light source 2012 to the optical filter 2014. In some examples, as shown in FIG. 19, the resulting narrowband light can be coupled to the spectral sensor 2002 via an optical diffuser 2018. The apparatus 2000 is again fully automated using a Y-stage motor 2020 and a Z-stage motor 2022 that can be controlled by a calibration control and processing DSP (e.g., control and processing unit) 2024 configured to execute, for example, calibration and testing software. In the example shown in FIG. 20, the optical diffuser 2018 is positioned on the Y-stage motor 2020, along with one or more reference materials 2026a and 2026b. In addition, the control and processing unit 2024 is further coupled to a light source controller 2028 configured to control the internal light source head 2004 of the spectral sensor 2002 and the external light source 2012.

In some examples, specular reflection of light from spectral device window 2006 can be measured to be compensated by including an empty socket slot (not shown) in the Y-stage slider 2020 to avoid any other reflected light except from the sensor optical interface window. In addition, as shown in FIG. 20, back-reflection from an extra (external) optical window 2030 can be also measured. In this example, a perfect absorber 2032 can be placed above the external optical window 2030 to prevent any reflection from the filter setup above. In either case, input light from the internal light source 2004 in the spectral sensor can be directed towards the optical window 2006/2030 and diffusely reflected light from the optical window 2006/2030 can be measured to by the calibration and control DSP 2024 to produce a specular back-reflection calibration parameter to compensate for specular back-reflection from the optical window 2006/2030.

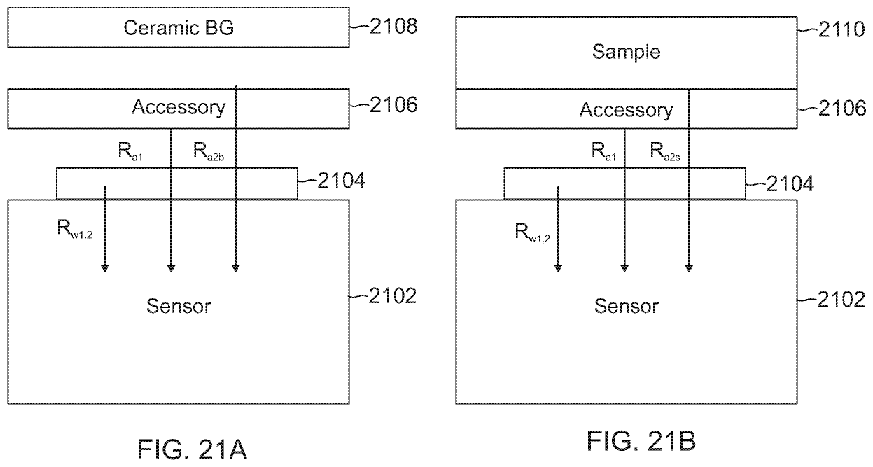

FIGS. 21A and 21B are diagrams illustrating examples of specular back-reflection sources according to some aspects. FIG. 21A illustrates an example of back-reflection analysis for background measurement, whereas FIG. 21B illustrates an example of back-reflection analysis for sample measurement. For example, in FIG. 21A, a ceramic tile 2108 is positioned above an optical window 2104 of a spectral sensor 2102, whereas in FIG. 21B a sample 2110 is positioned above the optical window 2104 of the spectral sensor 2102. In some examples, an optical window accessory 2106 may further be included between the optical window 2104 of the spectral sensor 2102 and the ceramic tile 2108/sample 2110.

Specular back-reflection sources can include, for example, the bottom surface (R_{w1}) of the spectral sensor optical window 2104 and the top surface (R_{w2}) of the spectral sensor optical window 2104. For the top surface specular back-reflection of the spectral sensor optical window 2104 without the optical window accessory 2106, the background (ceramic tile 2108) measurement can capture the air-window specular back-reflection R_{w2b}, while the sample (sample 2110) measurement can capture the sample-window specular back-reflection R_{w2s}. In addition, specular back-reflection sources can include the bottom surface (Rₐ₁) of the accessory optical window 2106 and the top surface (Rₐ₂) of the accessory optical window 2106. For the top surface specular back-reflection of the optical window accessory 2106, the background (ceramic tile 2108) measurement can capture the air-accessory specular back-reflection R_{a2b}, while the sample (sample 2110) measurement can capture the sample-window specular back-reflection Rₐ₂ₛ.

Back-reflection from the sample 2110 is dependent upon the sample nature and the refractive index. For example, heterogenous samples can have air gaps with respect to the optical window 2104/2106. For the extra optical window accessory 2106, assuming R_{w1}=R_{w2}=R_{w}/2, the PSD can be represented as:

PSD_{BR,BG}=PSDₒ(R_{w}+Rₐ₁+R_{a2b})

PSD_{BR,sample}=PSDₒ(R_{w}+Rₐ₁+Rₐ₂ₛ)

PSD_{BG}=PSD_{BR,BG}+PSDₒR_{BG}

PSDₛₐₘₚₗₑ=PSD_{BR,sample}+PSDₒRₛₐₘₚₗₑ

where PSDₒ is the spectral sensor PSD with 100% reflectance, R_{BG} is the background (BG) reflectance, and Rₛₐₘₚₗₑ is sample reflectance. Let:

BRₛₐₘₚₗₑ=R_{w}+Rₐ₁+Rₐ₂ₛ

BR_{BG}=R_{w}+Rₐ₁+R_{a2b}

Thus, back-reflection leads to absorbance saturation (non-linear absorbance scaling) as follows:

$${R}_{measured} = \frac{B {R}_{sample} + {R}_{sample}}{B {R}_{BG} + {R}_{BG}} = \frac{B {R}_{sample}}{B {R}_{BG} + {R}_{BG}} + \frac{{R}_{sample}}{B {R}_{BG} + {R}_{BG}} = \frac{B {R}_{sample}}{B {R}_{BG} + {R}_{BG}} + \frac{{R}_{sample}}{{R}_{BG}} - \frac{{R}_{sample}}{{R}_{BG}} \frac{B {R}_{BG} / {R}_{BG}}{1 + B {R}_{BG} / {R}_{BG}} ∼ \frac{B {R}_{sample}}{{R}_{BG}} + \frac{{R}_{sample}}{{R}_{BG}} ( 1 - \frac{B {R}_{BG}}{{R}_{BG}} )$$

$${R}_{measured} ∼ \frac{B {R}_{sample}}{{R}_{BG}} + \frac{{R}_{sample}}{{R}_{BG}} ( 1 - \frac{B {R}_{BG}}{{R}_{BG}} )$$

Therefore, sample reflectance with respect to background material reflectance can be extracted by correcting the measured reflectance after compensating for the back-reflection effect as follows:

$$\frac{{R}_{sample}}{{R}_{BG}} ∼ {R}_{measured} ( 1 + \frac{B {R}_{BG} - B {R}_{sample}}{{R}_{BG}} )$$

Back-reflection PSD or reflectance with respect to background reference material can be measured using the calibration setup/apparatus/system and stored on the sensor memory as a calibration setting (calibration data), to be used later in the real measurements in the field/lab and so on. Compensation can be performed on the PSD level, subtracting the measured BR PSD from the background PSD and the sample PSD respectively as:

$$\frac{P S {D}_{sample comp}}{P S {D}_{BG comp}} = \frac{P S {D}_{Sample} - P S {D}_{BR , Sample}}{P S {D}_{BG} - P S {D}_{BR , BG}}$$

$${R}_{comp} ∼ \frac{( {R}_{measured} * P S {D}_{BG} ) - ( B {R}_{sample , Spectrum} * P S {D}_{BG} )}{P S {D}_{BG} * ( 1 - B {R}_{BG , Spectrum} )}$$

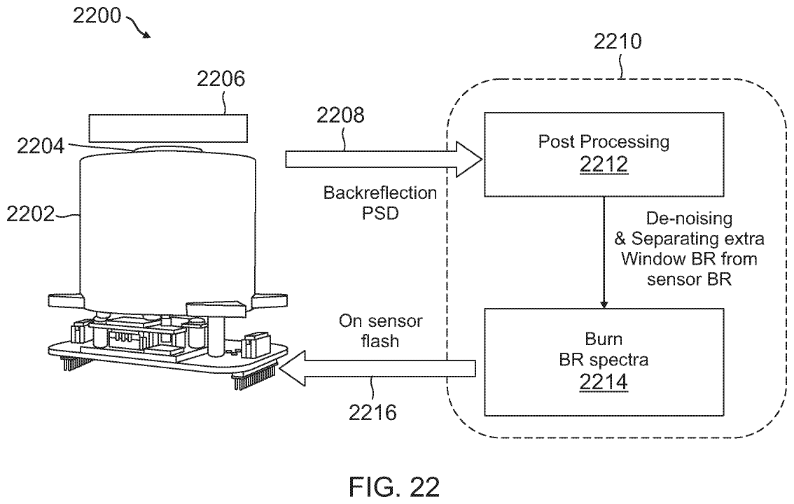

FIG. 22 is a diagram that illustrates an example of a back-reflection calibration apparatus according to some aspects. The apparatus 2200 includes a spectral sensor 2202 having an optical window 2204 thereon. In addition, an extra window jig 2206 can be added to the calibration apparatus moving stage (not shown) to be measured as an emulation of a measurement accessory to be attached to the spectral sensor 2202 in the field or in a bigger spectral scanner or system. In the example shown in FIG. 22, a measured back-reflection PSD 2208 is provided to a calibration control and DSP 2210, which performs post processing 2212 on the back-reflection PSD 2208 to smooth it, de-noise it, and separate sensor window back-reflection from extra window back-reflection. The calibration control and DSP 2210 can then burn back-reflection correction functions 2214 on the spectral sensor memory. A compensation function can be also applied across temperature by multiplying the BR compensation function by the spectral drift function D(T−To) across temperature with respect to the temperature of compensation calibration To, such that:

PSD_{BR,T}=PSD_{BR,T}_{ₒ}D(T−Tₒ)

In some examples, calibration and testing of a spectral sensor may include a MEMS test in which the spectral sensor performs white light measurements (e.g., using PTFE material) in addition to a dark current measurement to check the sensor MEMS parameters. Calibration may further include an alignment test in which the spectral sensor performs white light measurements (e.g., using PTFE material) to check the sensor optical parameters. A closed loop test may then be performed using white light measurements to set the actuation profile and then check the profile stability, followed by calibration using white light, Talc material, and laser diode output scans to calculate the CX curve and other calibration parameters that are then programmed onto the sensor. Spectral testing can then be performed to guarantee the spectral quality and reproducibility. For example, a back-reflection test with and without the extra window accessory may be performed, in addition to a spot size test and a signal-to-noise ratio (SNR) test (e.g., using a PTFE sheet). Other testing may include a wavelength repeatability test using, for example, a polystyrene sheet, a wavelength accuracy test using, for example, a polystyrene sheet and MRC 1920x reference material, and a spectral similarity test using, for example, a polystyrene sheet, MRC 1920x reference material, and back-reflection spectrum with the extra window accessory.

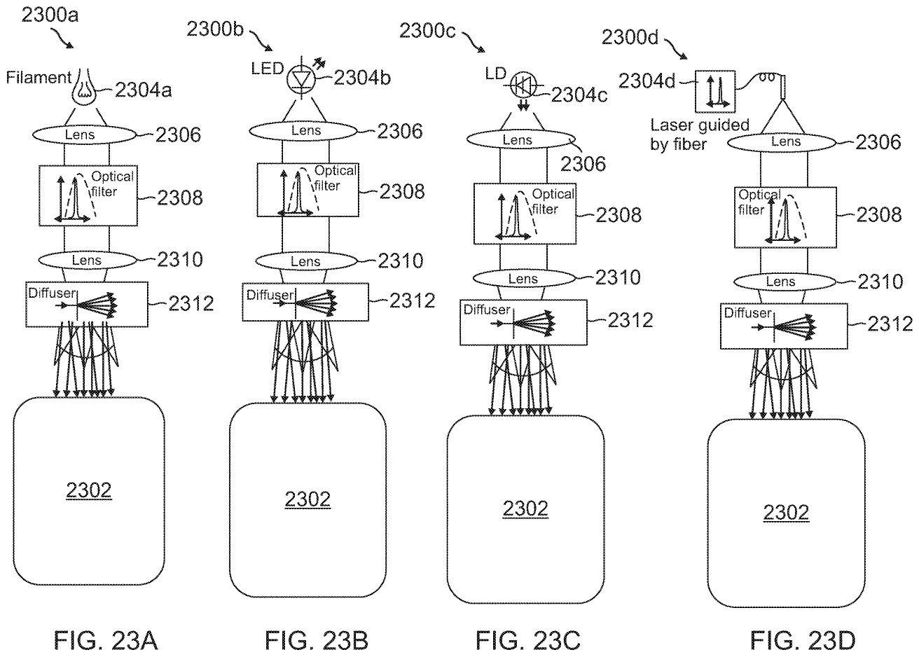

FIGS. 23A-23D are diagrams illustrating examples of a spectral calibration apparatus including different external calibration light sources according to some aspects. In each of FIGS. 23A-23D, the respective spectral calibration apparatus 2300a-2300d includes a diffuse-reflection spectral sensor 2302 configured to operate in a transmission mode in which output light from a respective external light source 2304a-2304b is collimated using a collimating lens 2306. The collimated light is then directed toward a single wavelength optical filter 2308, where the light is incident normally on the filter surface. Finally, a focusing lens 2310 is used to focus the light towards an engineered optical diffuser 2312 configured to emulate diffuse reflection of the light towards the optical aperture of the spectral sensor 2302.

In the example shown in FIG. 23A, the external light source 2304a is a filament (white light) source. The example shown in FIG. 23A can provide good calibration results with a low cost. However, the useful signal may not be large enough with respect to the noise. In addition, the filament 2304a can generate a non-uniform pattern that can add instability in the interferogram envelope. In the example shown in FIG. 23B, the external light source 2304b is a light emitting diode (LED). The example shown in FIG. 23B can also provide good calibration results with a low cost. However, the useful signal again may not be large enough with respect to the noise, and depending on the LED 2304b, it may not be possible to use one LED 2304b with multiple different optical filters.

In the example shown in FIG. 23C, the external light source 2304c is a laser diode (LD). In this example, if the LD 2304c is a single mode laser, there may not be a need for the optical filter 2308. However, if the LD 2304c is a multimode laser, the optical filter 2308 can be used to produce the narrowband light input to the spectral sensor 2302. The example shown in FIG. 23C can also provide good calibration results because of the high power that is received at the detector. However, depending on the LD 2304c, it may not be possible to use one LD 2304c with multiple filters. In the example shown in FIG. 23D, the external light source 2304d is a fiber laser. In this example, if the fiber laser 2304d is a single mode laser, there may not be a need for the optical filter 2308. However, if the fiber laser 2304d is a multimode laser, the optical filter 2308 can be used to produce the narrowband light input to the spectral sensor 2302. As with the example shown in FIG. 23C, the example shown in FIG. 23D can also provide good calibration results because of the high power that is received at the detector. However, depending on the fiber laser 2304d, it may not be possible to use one fiber laser 2304d with multiple filters.

Multimode LDs 2304c and fiber lasers 2304d may produce higher power and lower gain modes (wavelength modes), which may cause a variation in the power level during calibration. Therefore, in examples in which a multimode LD 2304c or fiber laser 2304d are used, an operating current for the LD 2304c/fiber laser 2304d that is at least twice the value of the threshold current may be used to keep the difference in power between the lower and higher gain modes minimized. In addition, a thermo-electric cooling (TEC) module may be used to move the multimode laser spectrum to keep the filter spectrum in the central area of the laser spectrum (e.g., since the filter spectrum is fixed). The TEC module can also be used to fine tune the position of the laser spectrum to keep any high gain modes away from the filter spectrum edges to get the highest stability for the laser power during the calibration process. The fine tuning of the TEC module may practically be performed by measuring the power from the laser source after the narrow band filter during a certain period of time based on the needed calibration time. Then, the power variation standard of deviation can be calculated and a fine-tune temperature step (for example 0.1 °C) can be changed one by one until the best stable case with the minimum value of the standard of deviation is found.

In each of the examples shown in FIGS. 23A-23D, the optical diffuser 2312 operates as a narrowband Lambertian source. For example, the diffuser 2312 can generate high power and narrowband light in a uniform distribution, which can be used to detect the self-apodization envelope with a high confidence level then the compensation function can be generated. In some examples, the diffuser angle may be larger than the numerical aperture of the spectral sensor 2302. In some examples, the diffuser 2312 may be rotated, which can produce changes in the signal envelope. In this example, the spot on the diffuser 2312 can be increased to collect signal from a larger diameter on the diffuser, collimated light on the diffuser (e.g., using the lens 2306) may be used to minimize the non-uniformity errors, and/or the rotation motion of the diffuser 2312 during calibration may be performed with a certain optimized angular speed around its center.

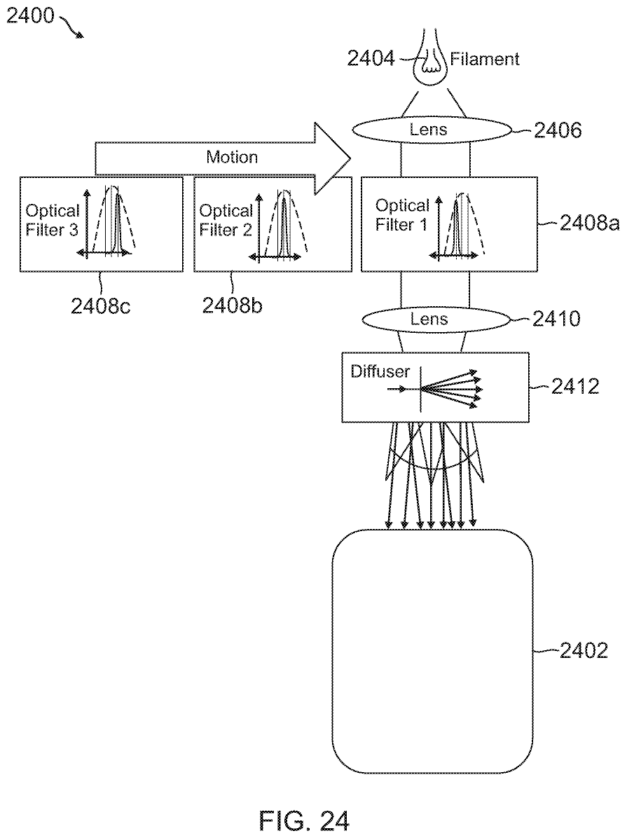

FIG. 24 is a diagram illustrating another example of an apparatus configured for automated spectral calibration according to some aspects. The apparatus 2400 (e.g., calibration apparatus) includes a diffuse-reflection spectral sensor 2402 configured to operate in a diffuse-reflectance mode. In some examples, the diffuse-reflection spectral sensor 2402 may also operate in a transmission mode with the use of an external calibration light source 2404 (e.g., a filament light source, as shown in FIG. 24, or other light source, such as an LD, fiber laser, filament, pumped plasma, supercontinuum laser, etc.). In the example shown in FIG. 24, output light from the filament 2404 is collimated using a collimating lens 2406. The collimated light is then directed toward one of a plurality of single wavelength narrowband optical filter 2408a-2408c. The plurality of optical filters 2408a-2408c may be positioned, for example, within sockets or slots on a Y-stage motor/stepper/slider (not specifically shown). The Y-stage motor may be configured to separately move between the optical filters 2408a-2408c within the optical path of the spectral sensor 2404 to measure the interferogram envelope at different wavelengths. Here, the light is incident normally on the filter surface, and thereby the spectral sensor 2404 can be calibrated at different wavelengths. Finally, a focusing lens 2410 is used to focus the light towards an engineered optical diffuser 2412 configured to emulate diffuse reflection of the light towards the optical aperture of the spectral sensor 2402.

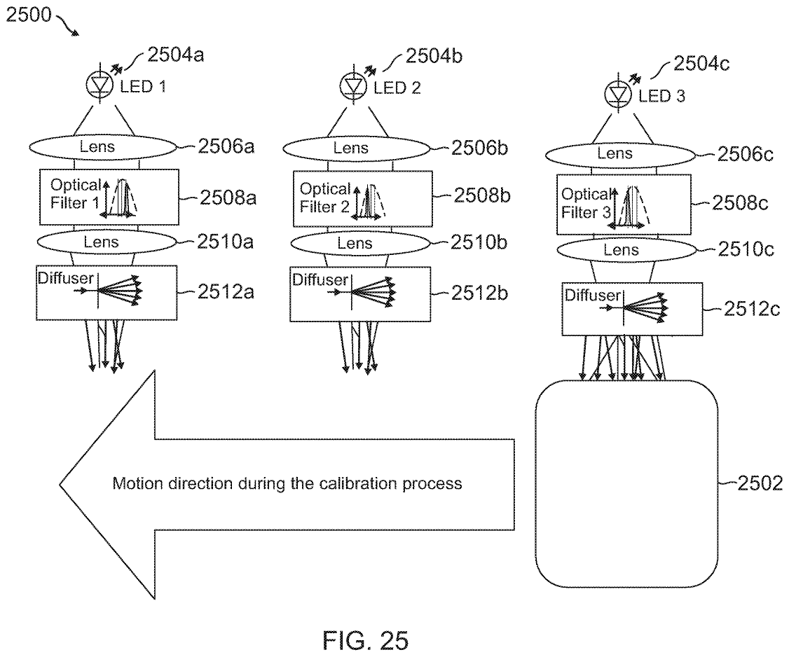

FIG. 25 is a diagram illustrating another example of an apparatus configured for automated spectral calibration according to some aspects. The apparatus 2500 (e.g., calibration apparatus) includes a diffuse-reflection spectral sensor 2502 configured to operate in a diffuse-reflectance mode. In some examples, the diffuse-reflection spectral sensor 2502 may also operate in a transmission mode with the use of an external calibration light source. In the example shown in FIG. 25, three different external light sources 2504a, 2504b, or 2504c are shown. For example, three different LED light sources (LED1 2504a, LED2 2504b, and LED 2504c) are illustrated. However, it should be understood that any type of light source (e.g., LD, fiber laser, filament, pumped plasma, supercontinuum laser, etc.) may be used in the example of FIG. 25.

Each external light source 2504a-2504c is configured to direct output light therefrom to a respective collimating lens 2506a-2506c. The respective collimated light from each collimating lens 2506a-2506c can then be directed toward a respective single wavelength narrowband optical filter 2508a-2508c. Finally, a respective focusing lens 2510a-2510c can be used to focus the light towards a respective engineered optical diffuser 2512a-2512c configured to emulate diffuse reflection of the light towards the optical aperture of the spectral sensor 2502. In the example shown in FIG. 15, the spectral sensor 2502 may positioned on a Y-stage (not specifically shown) that is configured to move between the optical filters 2508a-2508c to calibrate the spectral sensor 2502 at different wavelengths.

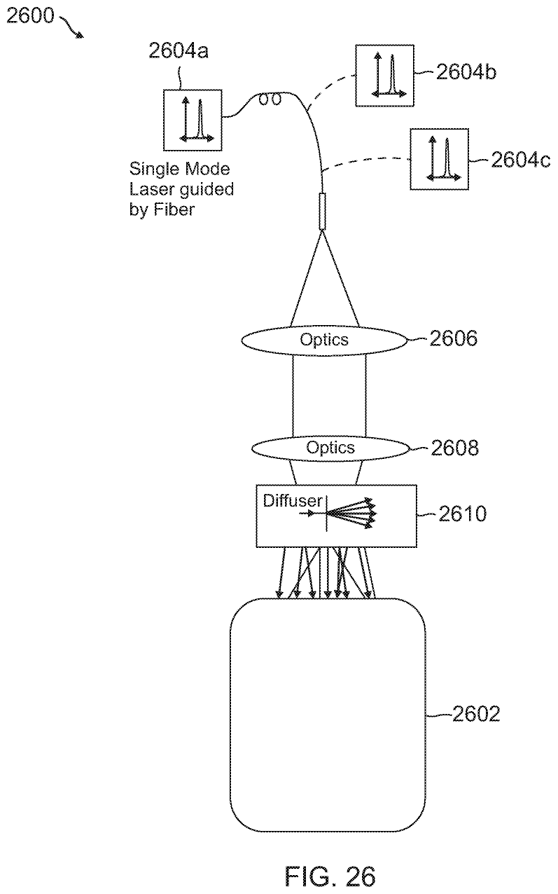

FIG. 26 is a diagram illustrating another example of an apparatus configured for automated spectral calibration according to some aspects. The apparatus 2600 (e.g., calibration apparatus) includes a diffuse-reflection spectral sensor 2602 configured to operate in a diffuse-reflectance mode. In some examples, the diffuse-reflection spectral sensor 2602 may also operate in a transmission mode with the use of an external calibration light source. In the example shown in FIG. 26, three different external light sources 2604a, 2604b, or 2604c are shown. For example, three different single mode laser light sources are illustrated. In the example shown in FIG. 26, output light from one of the single mode laser sources 2604a, 2604b, or 2604c is collimated using a collimating lens 2606. As a single mode laser source is used, an optical narrowband filter may not be needed to produce the desired wavelength (and therefore is not shown in FIG. 26). However, in some examples, a narrowband optical filter may also be used in conjunction with a single mode laser (e.g., in examples in which the single mode laser has a line width wider than the optical bandpass filter). A focusing lens 2608 is then used to focus the light towards an engineered optical diffuser 2610 configured to emulate diffuse reflection of the light towards the optical aperture of the spectral sensor 2602. In the example shown in FIG. 26, multiple laser sources 2604a-2604c with an optical fiber recoupled between them is used as a light source and the calibration is repeated after switching between different wavelengths (different laser sources 2604a-2604c).

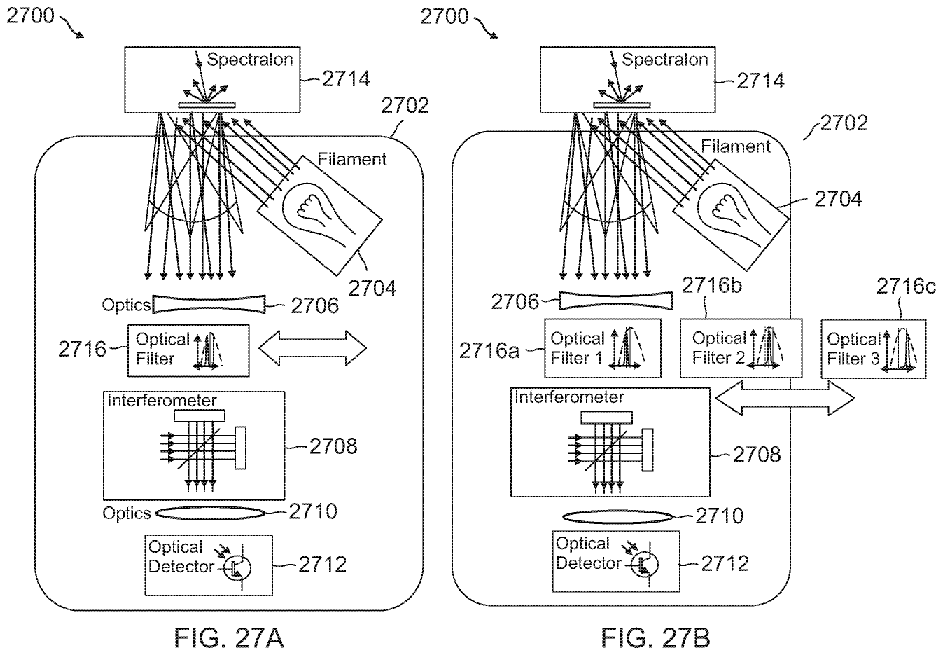

FIGS. 27A and 27B are diagrams illustrating other examples of an apparatus configured for automated spectral calibration according to some aspects. The apparatus 2700 (e.g., calibration apparatus) includes a diffuse-reflection spectral sensor 2702 configured to operate in a diffuse-reflectance mode. The spectral sensor 2702 includes an internal light source 2704 (e.g., filaments) configured to generate input light that is directed towards an optical window of the spectral sensor 2702 on which a sample-under-test (SUT), not shown, may be placed. The input light from the internal light source 2704 can be diffusely reflected from the SUT and the diffusely reflected light is then directed via, for example, input optics 2706 (e.g., reflectors or lenses) towards an interferometer 2708 (e.g., light modulator) configured to produce modulated light that is focused by output optics 2710 onto an optical detector 2712 (e.g., photo detector or photo detector array).

FIGS. 27A and 27B illustrate a reflection mode calibration in which a single wavelength narrowband optical filter 2716 is inserted into the spectral sensor 2702 after the input optics 2706 that focuses the light into the interferometer 2708. In addition, the sample is replaced by a reference material 2714 (e.g., a high flux Spectralon) to facilitate diffuse reflection of the input light for calibration of the spectral sensor 2702. In the example shown in FIG. 27B, multiple wavelength optical filters 2716a-2716c may be separately inserted into the spectral sensor 2702. In this example, the optical filters 2716a-2716c may be attached to a motorized stage (e.g., Y-stage or other robotic arm) to enable moving between filters 2716a-2716c to perform calibration across multiple wavelengths.

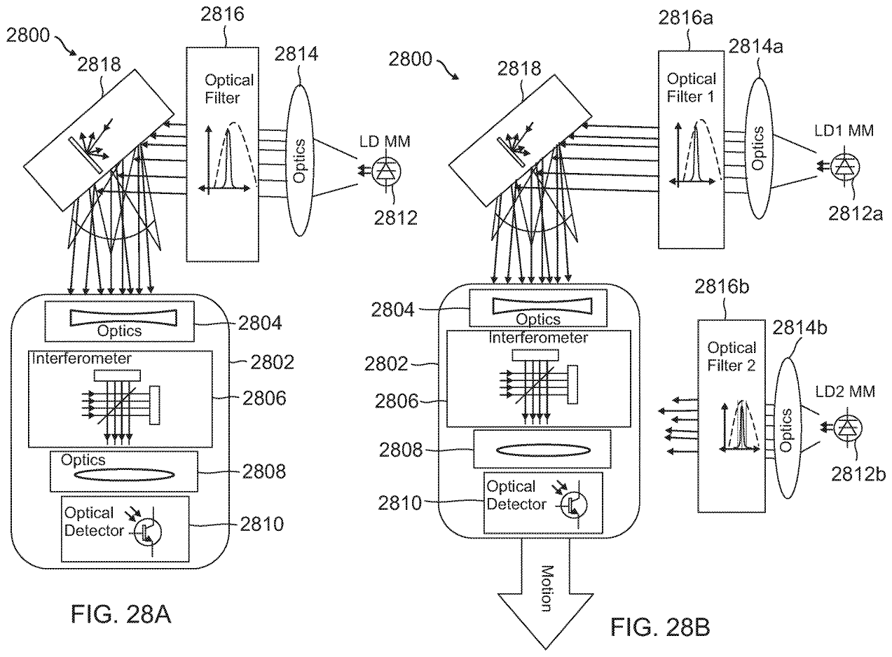

FIGS. 28A and 28B are diagrams illustrating other examples of an apparatus configured for automated spectral calibration according to some aspects. The apparatus 2800 (e.g., calibration apparatus) includes a diffuse-reflection spectral sensor 2802 configured to operate in a diffuse-reflectance mode. The spectral sensor 2802 includes an internal light source (not shown) configured to generate input light that is directed towards an optical window of the spectral sensor 2802 on which a sample-under-test (SUT), not shown, may be placed. The input light can be diffusely reflected from the SUT and the diffusely reflected light is then directed via, for example, input optics 2804 (e.g., reflectors or lenses) towards an interferometer 2806 (e.g., light modulator) configured to produce modulated light that is focused by output optics 2808 onto an optical detector 2810 (e.g., photo detector or photo detector array).

FIGS. 28A and 28B illustrate a reflection mode calibration in which an external light source (e.g., LD or other suitable external calibration light source) 2812 is configured to generate output light that is collimated by the use of a collimating lens 2814 and directed towards a single wavelength narrowband optical filter 2816, where the light is incident normally on the filter surface. The single wavelength (narrowband) light output from the optical filter 2816 is then directed towards a tilted reflection diffuser 2818 (or Spectralon with a tile angle of 45 degrees) to diffusely reflect the narrowband light towards the input optics 2804.

In the example shown in FIG. 28B, multiple wavelength optical filters 2816a and 2816b may be separately coupled to respective collimating lenses 2814a and 2414b and external light sources 2812a and 2812b. In this example, the spectral sensor 2802 and tilted reflection diffuser 2818 may be positioned onto a Y-stage and moved between the filters 2816a and 2816b to perform calibration across multiple wavelengths. In other examples, instead of using different wavelength filters 2816a and 2816b, different single mode lasers 2812a and 2812b may be used without the filters.

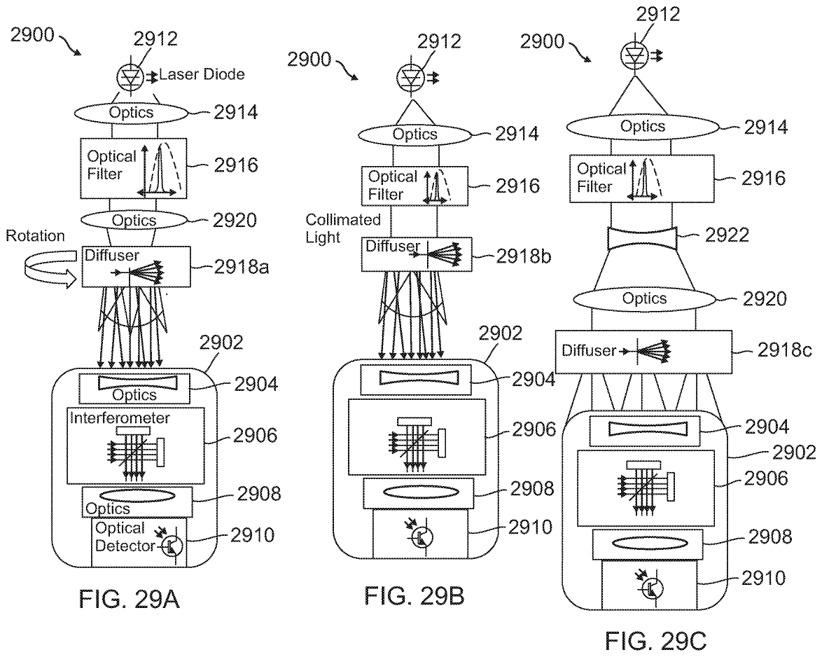

FIGS. 29A-29C are diagrams illustrating other examples of apparatuses configured for automated spectral calibration according to some aspects. The illustrated apparatuses 2900a-2900c (e.g., calibration apparatus) each includes a diffuse-reflection spectral sensor 2902 configured to operate in a diffuse-reflectance mode. The spectral sensor 2902 includes an internal light source (not shown) configured to generate input light that is directed towards an optical window of the spectral sensor 2902 on which a sample-under-test (SUT), not shown, may be placed. The input light can be diffusely reflected from the SUT and the diffusely reflected light is then directed via, for example, input optics 2904 (e.g., reflectors or lenses) towards an interferometer 2906 (e.g., light modulator) configured to produce modulated light that is focused by output optics 2908 onto an optical detector 2910 (e.g., photo detector or photo detector array).

In addition, each of the apparatuses 2900a-2900c includes an external light source 2912 (e.g., a LD or other suitable light source) configured to generate output light that is collimated by the use of a collimating lens 2914 and directed towards a single wavelength narrowband optical filter 2916, where the light is incident normally on the filter surface. The single wavelength (narrowband) light output from the optical filter 2916 is then directed towards a respective optical diffuser 2918a-2918c. In the example shown in FIG. 29A, the narrowband light from the optical filter is focused by a focusing lens onto the optical diffuser 2918a. In this example, the optical diffuser 2918a is positioned on a motorized rotating ring that rotates the diffuser 2918a with a certain angular speed that provides the ability to obtain an averaged signal from the diffuser 2918a. In this type of motorized solution, good results can be achieved without being affected by diffuser manufacturing errors. In the example shown in FIG. 29B, the narrowband and collimated light from the optical filter 2916 is incident directly on the optical diffuser 2918b and made perpendicular to the diffuser 2918b to minimize the effects of diffuser manufacturing defects. Further improvement can be achieved by increasing the illumination spot on the diffuser 2918c shown in FIG. 29C through the use of multiple lenses 2920 and 2922, as a larger spot size provides an average value for the diffuser manufacturing errors, thus providing better uniformity and better results.

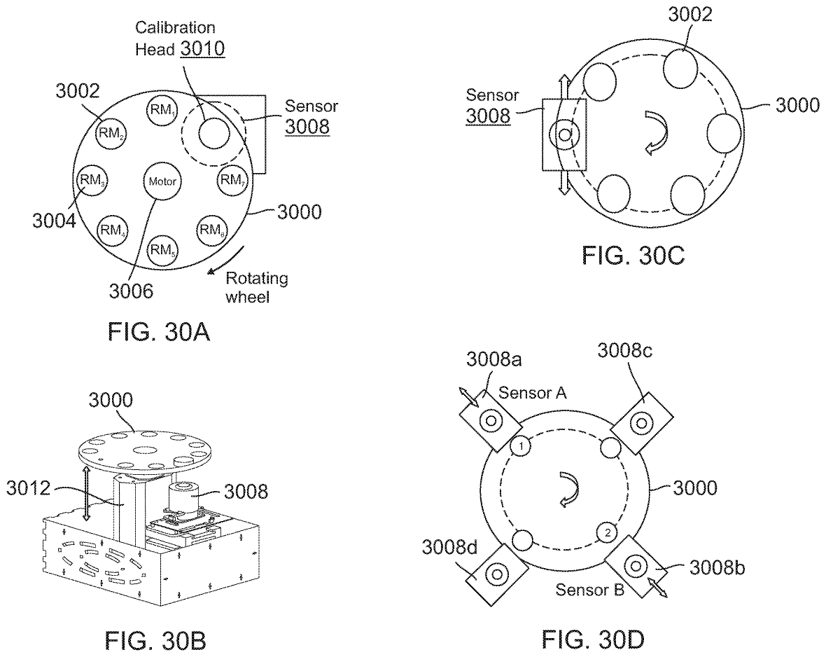

FIGS. 30A-30D are diagrams illustrating examples of a rotating calibration wheel according to some aspects. As shown in FIGS. 30A-30D, the rotating calibration wheel 3000 (e.g., a Y-stage rotating wheel) includes a plurality of sockets/slots 3002 within which various optical elements (e.g., reference materials, filters, optical windows, lenses, etc.) 3006 may be placed. The rotating calibration wheel 3000 may be controlled via a motor 3006 configured to rotate the wheel 3000 until a desired optical element 3004 is placed above a spectral sensor/device being calibrated. The rotating calibration wheel 3000 may be configured to rotate under a calibration head 3010, which may include, for example, an external light source, optical filter, lenses, etc. In some examples, the rotating calibration wheel 3000 may further be positioned on a Z-stage 3012 configured to move the rotating wheel 3000 up and down for alignment of the optical elements 3004 with the optical path of the spectral sensor 3008.

In the example shown in FIG. 30D, parallel testing of multiple spectral sensors 3008a-3008d can be performed, thus increasing utilization of the rotating calibration wheel 3000. This can enable spectral correction or transfer of each new spectral sensor to a golden sensor(s), extracting the required mathematical transfer function to be saved onto the sensor memory as a part of the calibration configurations/settings (e.g., calibration data).

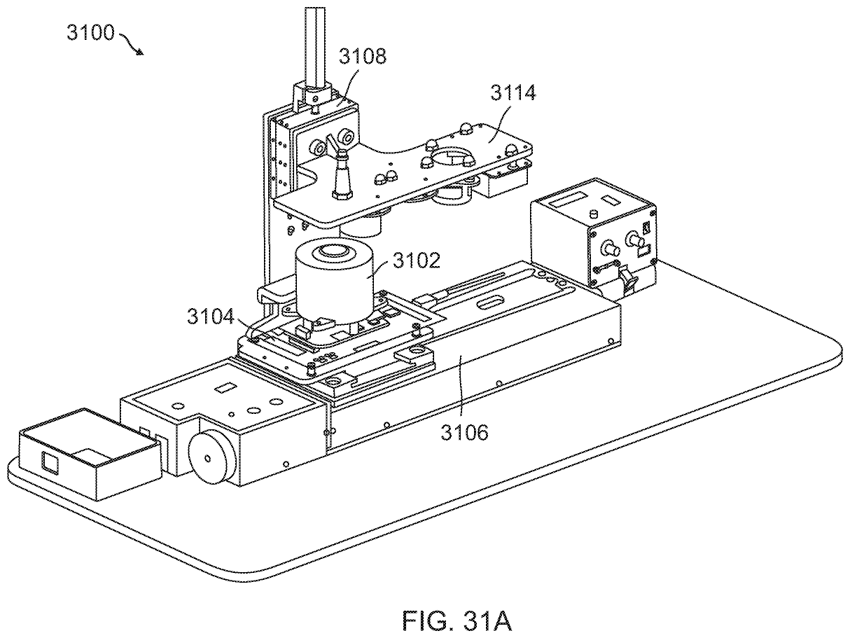

FIGS. 31A-31C are diagrams illustrating another example of an apparatus configured for automated spectral calibration according to some aspects. In the example shown in FIGS. 31A-31C, one or more spectral sensors 3102 (e.g., 3102a and 3102b) may be positioned on respective testing boards 3104 (e.g., 3104a and 3104b) and each of the testing boards 3104a and 3104b may be placed on a horizontal stage (Y-stage) configured to automate testing of the spectral sensors 3102a and 3102b by moving the spectral sensors 3102a and 3102b to position one of a plurality of optical elements 3110 (e.g., reference materials, optical filters, optical diffusers, optical window accessories, lenses, etc.) within the optical path of a spectral sensor (e.g., sensor 3102a) under test. In this example, the optical elements 3110 may be fixed on a horizontal board 3114. In some examples, one or more of the optical elements (e.g., one or more optical filters) may be inserted into the spectral sensor 3102. The horizontal board 3114 may be coupled to a vertical stage (Z-stage) 3108 configured to move the horizontal board 3114 up and down to align the optical element(s) 3110 with the spectral sensor(s) 3102 under test. To ensure proper alignment and pressure control of reference material 3110 placement above the spectral sensor 3102 during testing, one or more infrared (IR) sensors 3112 may be positioned on the horizontal board 3114 to control vertical axis (Z-stage 3108) alignment.

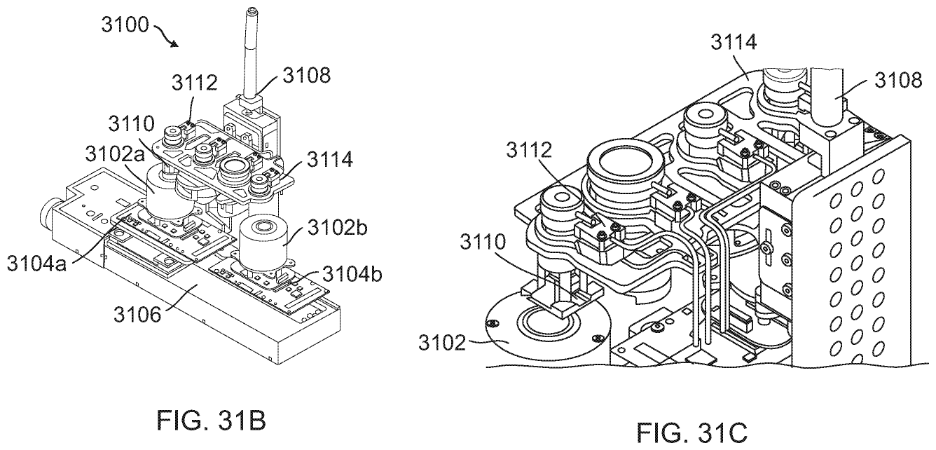

FIG. 32 is a diagram illustrating an example of vertical axis alignment according to some aspects. In the example shown in FIG. 32, a spectral sensor 3202 under test is placed on a motorized Y-stage (not specifically shown) to position the spectral sensor 3202 under an optical element (e.g., a reference material, optical filter, lens, optical window accessory, etc.) or sample under test (SUT) 3212 that is contained within a holder (socket/slot) 3206 positioned on a horizontal board 3210 (e.g., as shown in FIGS. 31A-31C). In some examples, the horizontal board is coupled to a Z-stage 3204 that includes a highly accurate motor to move the holder 3206 up and down above the spectral sensor 3202.

One or more IR sensors 3208 with a tapered design are placed on the horizontal board 3210 and can be configured to generate a signal (e.g., feedback) to a control unit (e.g., calibration control and processing unit) when the holder 3206 touches (e.g., comes into contact with) the spectral sensor optical window 3214. This ensures proper placement of reference materials and other optical elements above the spectral sensor and ensures repeatability in placement pressure of reference materials across measurements. In some examples, the tapered design ensures that the reference material consistently remains properly positioned above the spectral sensor. Additionally this design allows the reference material to move downward under its own weight, maintaining reliable contact and alignment.

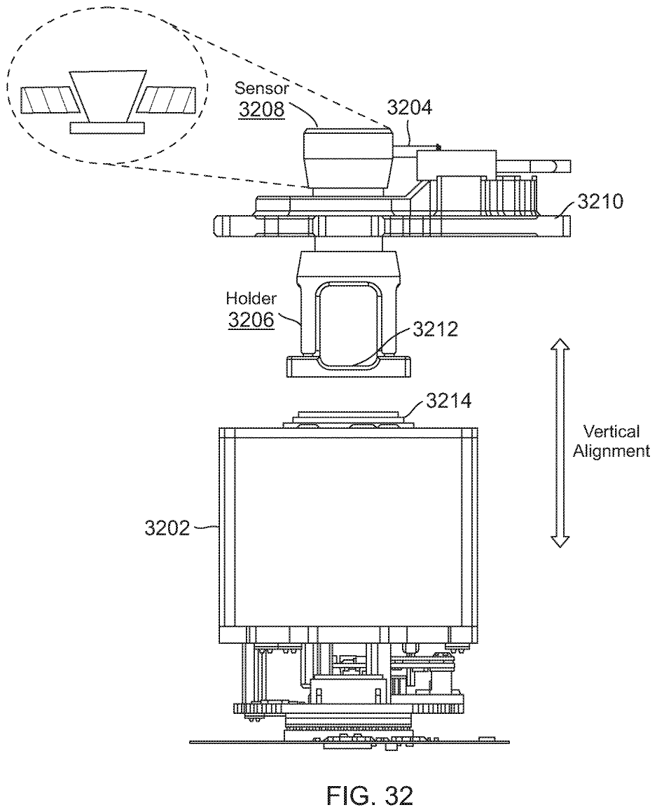

FIG. 33 is a diagram illustrating an example of horizontal axis alignment according to some aspects. In the example shown in FIG. 33, a spectral sensor 3302 under test is placed on a highly accurate motorized Y-stage 3316 to accurately position the spectral sensor 3302 under an optical element 3312 (e.g., a reference material, optical filter, lens, optical window accessory, etc.) that is contained within a holder (socket/slot) 3306 positioned on a horizontal board 3310 (e.g., as shown in FIGS. 31A-31C). The horizontal board is further coupled to a Z-stage 3304 to move the holder 3306 up and down above the spectral sensor 3302. By use of a camera 3308 or manual calibration, a control unit (e.g., control and processing unit) coupled to the Y-stage 3316 and Z-stage 3304 can correct any misalignment and ensure that the spectral sensor 3302 and reference material 3312 are properly aligned. For example, the camera 3308 can be configured to provide a feedback signal to the control unit to control the motorized Y-stage 3316 for horizontal axis alignment.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-33 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-33 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An apparatus configured for automated spectral calibration, comprising:
a diffuse-reflection spectral sensor comprising a light modulation module;
a motorized positioning mechanism configured to automatically alternately position one or more of a plurality of optical elements within an optical path of the diffuse-reflection spectral sensor; and
a control and processing unit configured to control the motorized positioning mechanism and the diffuse-reflection spectral sensor to dynamically switch between at least a first calibration state to direct a first optical signal based on wideband light and a first selected optical element of the plurality of optical elements to the light modulation module and a second calibration state to direct a second optical signal based on narrowband light and a second selected optical element of the plurality of optical elements to the light modulation module, wherein the control and processing unit is further configured to acquire respective detected signals from the diffuse-reflection spectral sensor in each of the first calibration state and the second calibration state and produce calibration data based on the detected signals.

2. The apparatus of claim 1, further comprising:
an external light source that is configured to direct output light towards the diffuse-reflection spectral sensor to produce the narrowband light in the second calibration state.

3. The apparatus of claim 2, wherein the second selected optical element comprises an optical bandpass filter placed adjacent to or on the motorized positioning mechanism.

4. The apparatus of claim 3, wherein the external light source is configured to illuminate the optical bandpass filter using a wide spot collimated light to produce the narrowband light.

5. The apparatus of claim 3, wherein the plurality of optical elements comprises an optical diffuser configured to emulate diffuse reflection of the narrowband light to produce the second optical signal, wherein the optical diffuser is placed between the external light source and the motorized positioning mechanism, on the motorized positioning mechanism, or between the motorized positioning mechanism and the diffuse-reflection spectral sensor.

6. The apparatus of claim 5, wherein the control and processing unit is configured to rotate the optical diffuser around an optical axis thereof.

7. The apparatus of claim 5, wherein the optical diffuser comprises a transmission diffuser.

8. The apparatus of claim 5, wherein the optical diffuser comprises a tilted reflection diffuser positioned at a forty-five degree angle with respect to an optical window of the diffuse-reflection spectral sensor.

9. The apparatus of claim 3, wherein the external light source is configured to produce white light.

10. The apparatus of claim 8, wherein the optical bandpass filter comprises an optical multiband filter.

11. The apparatus of claim 3, wherein the external light source comprises a narrowband light source comprising a line width wider than the optical bandpass filter.

12. The apparatus of claim 11, further comprising a thermo-electric cooling (TEC) module coupled to the external light source.

13. The apparatus of claim 3, wherein the plurality of optical elements comprises a first lens configured to direct the output light from the external light source to the optical bandpass filter and a second lens configured to direct the second optical signal to the diffuse-reflection spectral sensor.

14. The apparatus of claim 13, further comprising a slit above the motorized positioning mechanism and configured to insert either the optical bandpass filter in the second calibration state or a sample material in a transmission mode of the diffuse-reflection spectral sensor.

15. The apparatus of claim 2, wherein the external light source is coupled to an optical fiber configured to couple the second optical signal comprising the narrowband light to the diffuse-reflection spectral sensor.

16. The apparatus of claim 2, further comprising:
a light source controller configured to control one or more of a position of the external light source or a power of the external light source.

17. The apparatus of claim 2, further comprising a plurality of external light sources and a plurality of respective optical bandpass filters corresponding to the plurality of optical elements, wherein the motorized positioning mechanism is configured to move the diffuse-reflection spectral sensor between the plurality of external light sources.

18. The apparatus of claim 2, wherein the motorized positioning mechanism further comprises a plurality of optical bandpass filters placed thereon, wherein the motorized positioning mechanism is configured to position one of the plurality of optical bandpass filters within the optical path of the diffuse-reflection spectral sensor.

19. The apparatus of claim 2, wherein the external light source comprises a laser diode, light-emitting diode, one or more filaments, a super-continuum laser, multiple laser sources, or a laser pumped plasma source.

20. The apparatus of claim 1, wherein the plurality of optical elements are fixed on a horizontal board and the motorized positioning mechanism comprises a motorized Y-stage configured to move the diffuse-reflection spectral sensor between the plurality of optical elements.

21. The apparatus of claim 20, wherein the motorized positioning mechanism further comprises a motorized Z-stage configured to align the motorized Y-stage with the diffuse-reflection spectral sensor, wherein the horizontal board comprises one or more sensors configured to provide feedback to the control and processing unit to control the motorized Z-stage for vertical axis alignment of an optical element of the plurality of optical elements with an optical window of the diffuse-reflection spectral sensor.

22. The apparatus of claim 20, further comprising:
a camera configured to provide feedback to the control and processing unit to control the motorized Y-stage for horizontal axis alignment of an optical element of the plurality of optical elements with an optical window of the diffuse-reflection spectral sensor.

23. The apparatus of claim 1, wherein the diffuse-reflection spectral sensor further comprises an internal wideband light source configured to produce input light that is directed to an optical window of the diffuse-reflection spectral sensor for specular reflection thereof back into an optical aperture of the diffuse-reflection spectral sensor coupled to the light modulation module.

24. The apparatus of claim 23, wherein the plurality of optical elements comprises an optical bandpass filter, and wherein the motorized positioning mechanism comprises the optical bandpass filter and is configured to insert the optical bandpass filter into the diffuse-reflection spectral sensor through an opening thereof and to position the optical bandpass filter above the light modulation module in the second calibration state.

25. The apparatus of claim 24, wherein the plurality of optical elements further comprises at least one reference material, and wherein the motorized positioning mechanism is further configured to position a reference material of the at least one reference material above the optical window of the diffuse-reflection spectral sensor in the second calibration state to diffusely reflect the input light towards the optical bandpass filter through the optical aperture.

26. The apparatus of claim 23, wherein the input light comprises the wideband light in the first calibration state and the plurality of optical elements further comprises at least one reference material, and wherein the motorized positioning mechanism is configured to position a reference material of the at least one reference material above the optical window of the diffuse-reflection spectral sensor in the first calibration state to diffusely reflect the input light towards the light modulation module through the optical aperture.

27. The apparatus of claim 26, wherein the reference material comprises a perfect absorber placed above a second optical window on the motorized positioning mechanism, wherein the motorized positioning mechanism is configured to position the second optical window and the perfect absorber above the optical window of the diffuse-reflection spectral sensor to capture specular back-reflection of the input light from the second optical window.

28. The apparatus of claim 23, wherein the motorized positioning mechanism comprises an empty socket configured to capture specular back-reflection of the input light from the optical window of the diffuse-reflection spectral sensor.

29. The apparatus of claim 1, wherein the motorized positioning mechanism comprises a motorized Y-stage that comprises a plurality of sockets, each configured to hold one of the plurality of optical elements, wherein the motorized Y-stage comprises a motorized Y-stage slider or motorized Y-stage rotating wheel.

30. The apparatus of claim 29, wherein the motorized positioning mechanism further comprises a motorized Z-stage configured to align the motorized Y-stage with the diffuse-reflection spectral sensor.

31. The apparatus of claim 30, further comprising:
a proximity sensor configured to detect a distance between an optical element of the plurality of optical elements and the diffuse-reflection spectral sensor and to control the motorized Z-stage based on the distance.

32. The apparatus of claim 30, wherein the motorized Z-stage further comprises one or more slits configured to receive respective samples under test in a transmission mode of the diffuse-reflection spectral sensor.

33. The apparatus of claim 1, further comprising:
an electrical board comprising a socket in which the diffuse-reflection spectral sensor is placed to enable electrical connectivity with the diffuse-reflection spectral sensor.

34. The apparatus of claim 1, wherein the diffuse-reflection spectral sensor further comprises a memory configured to store the calibration data.

35. The apparatus of claim 34, wherein the light modulation module comprises a micro-electromechanical systems (MEMS) interferometer comprising a moveable mirror and a fixed mirror, and wherein the control and processing unit is further configured to calibrate a capacitance-to-optical path difference (OPD) relation (C2X relation) that represents a respective capacitance applied to the moveable mirror for each of a plurality of OPDs between the moveable mirror and the fixed mirror based on a narrowband interferogram signal obtained in the second calibration state, wherein the calibration data comprises the C2X relation.

36. The apparatus of claim 35, wherein the control and processing unit is further configured to:
obtain a capacitance signal versus time and a corresponding interferogram current signal versus time of a white light interferogram recorded for both directions of mirror displacement of the moveable mirror across a travel range thereof;
minimize a delay between the interferogram current signal and the capacitance signal for delay compensation of the diffuse-reflection spectral sensor; and
produce the C2X relation based on the delay compensation.

37. The apparatus of claim 35, wherein the control and processing unit is further configured to extract an envelope of the narrowband interferogram signal using a Hilbert transform and to produce a self-apodization calibration function of the calibration data based on the extracted envelope, wherein the self-apodization calibration function is configured to compensate for self-apodization resulting from light diffraction during movement of the moveable mirror.

38. The apparatus of claim 37, wherein the narrowband interferogram signal is obtained based on an optical bandpass filter of the plurality of optical elements, wherein the control and processing unit are further configured to divide the extracted envelope by a Fourier transform of a response of the optical bandpass filter to produce a self-apodization curve, invert and smooth the self-apodization curve to generate an optimized self-apodization compensation envelope, and fit the optimized self-apodization compensation envelope to a high order polynomial to produce the self-apodization calibration function.

39. The apparatus of claim 38, wherein the narrowband interferogram signal comprises a first narrowband interferogram signal associated with a first optical bandpass filter and a second narrowband interferogram signal associated with a second optical bandpass filter, and wherein the control and processing unit is further configured to extract a self-apodization envelope matrix across an optical path difference (OPD) of the MEMS interferometer and wavelength by interpolating between and extrapolating outside a respective wavelength range of each of the first optical bandpass filter and the second optical bandpass filter across a wavelength range of interest, wherein the control and processing unit is further configured to produce the self-apodization calibration function based on the self-apodization envelope matrix.

40. The apparatus of claim 35, wherein the control and processing unit is further configured to extract a known envelope of a known interferogram of a known material at one or more wavelength ranges using a Hilbert transform and to extract a measured envelope of a measured interferogram of the known material at the one or more wavelength ranges using the Hilbert transform, wherein the measured interferogram is obtained in the first calibration state, wherein the control and processing unit is further configured to divide the known envelope by the measured envelope to produce a self-apodization calibration function of the calibration data, wherein the self-apodization calibration function is configured to compensate for self-apodization resulting from light diffraction during movement of the moveable mirror.

41. The apparatus of claim 35, wherein the control and processing unit is configured to produce a wavelength correction calibration parameter of the calibration data using a white light power spectral density (PSD) of a white light interferogram recorded across a travel range of the moveable mirror and respective reference material PSDs of respective interferogram signals related to one or more known reference materials of the plurality of optical elements.

42. The apparatus of claim 41, wherein the control and processing unit is configured to, for each of the respective reference material PSDs, divide the respective reference material PSD associated with a known reference material of the one or more known reference materials by the white light PSD to obtain a respective absorbance spectrum of the known reference material, wherein the control and processing unit is further configured to correct respective peaks of the respective absorbance spectrums with respect to known positions of the respective peaks using a best-fitting multiple linear regression polynomial to produce the wavelength correction calibration parameter.

43. The apparatus of claim 35, wherein the control and processing unit is configured to produce a specular back-reflection calibration parameter to compensate for specular back-reflection from an optical window of the diffuse-reflection spectral sensor or an external optical window external to the diffuse-reflection spectral sensor based on one or more interferogram signals obtained in the first calibration state.

44. The apparatus of claim 1, wherein the control and processing unit is further configured to control the motorized positioning mechanism and the diffuse-reflection spectral sensor to perform one or more tests on the diffuse-reflection spectral sensor after calibration thereof, wherein the one or more tests comprises at least one of a back-reflection test, a spot size test, a signal to noise ratio test, a wavelength repeatability test, a wavelength accuracy test, or a spectral similarity test.
